(19) United States
(12) Patent Application Publication
(10) Pub. No.: US 2021/0319130 A1
(43) Pub. Date: Oct. 14, 2021

(54) EFFICIENTLY SCALABLE SYSTEMS

(71) Applicant: Facebook, Inc., Menlo Park, CA (US)

(72) Inventors: Yi Huang, Pleasanton, CA (US); Wenlong Dong, Clyde Hill, WA (US); Marc Alexander Celani, Naperville, IL (US); Xianliang Zha, El Dorado Hills, CA (US); Yunqing Chen, Los Altos, CA (US); Harikrishna Madadi Reddy, SanJose, CA (US); Junqiang Lan, Fremont, CA (US); Chien Cheng Liu, San Jose, CA (US); Raghuvardhan Moola, Fremont, CA (US); Haluk Ucar, Los Gatos, CA (US); Sujith Srinivasan, Fremont, CA (US); Handong Li, Union City, CA (US); Xing Cindy Chen, Los Altos, CA (US); Tuo Wang, San Jose, CA (US); Zhao Wang, Newark, CA (US); Baheerathan Anandharengan, Milpitas, CA (US); Gaurang Chaudhari, Sunnyvale, CA (US); Prahlad Rao Venkatapuram, Saratoga, CA (US); Srikanth Alaparthi, Fremont, CA (US); James Alexander Morle, Dripping Springs, TX (US); Vincent Matthew Malfa, Thousand Oaks, CA (US); Yassir Azziz, Belmont, CA (US); Chien-Chung Chen, Thousand Oaks, CA (US); Yan Cui, Newark, CA (US); Pedro Eugenio Rocha Pedreira, San Francisco, CA (US); Stavros Harizopoulos, San Francisco, CA (US)

(21) Appl. No.: 17/354,957

(22) Filed: Jun. 22, 2021

Related U.S. Application Data
(60) Provisional application No. 63/143,549, filed on Jan. 29, 2021.
(60) Provisional application No. 63/150,759, filed on Feb. 18, 2021.
(60) Provisional application No. 63/153,024, filed on Feb. 24, 2021.
(60) Provisional application No. 63/195,996, filed on Jun. 2, 2021.
(60) Provisional application No. 63/211,290, filed on Jun. 16, 2021.
(60) Provisional application No. 63/211,900, filed on Jun. 17, 2021.
(60) Provisional application No. 63/191,503, filed on May 21, 2021.

(51) Int. Cl. G06F 21/62; G06F 16/22; G06F 16/901; G06T 3/40

(52) U.S. Cl. CPC G06F 21/6218; G06T 3/40; G06F 16/9024; G06F 16/2282

(57) ABSTRACT

The disclosed may include various systems and methods for improving the efficiency and scalability of large-scale systems. For example, the disclosed may include systems and methods for automatic privacy enforcement using privacy-aware infrastructure, scalable general-purpose low cost integer motion search, efficient scaler filter coefficients layout for flexible scaling quality control with limited hardware resources, hardware optimization for power saving with both different codecs enabled, optimizing storage overhead and performance for large distributed data warehouse, mass and volume efficient integration of intersatellite link terminals to a satellite bus, and overcoming retention limit for memory-based distributed database systems.

### CROSS REFERENCE TO RELATED APPLICATION

This application claims the benefits of U.S. Provisional Application No. 63/143,549, filed Jan. 29, 2021, U.S. Provisional Application No. 63/150,759, filed Feb. 18, 2021, U.S. Provisional Application No. 63/153,024, filed Feb. 24, 2021, U.S. Provisional Application No. 63/191,503, filed May 21, 2020, U.S. Provisional Application No. 63/195,996, filed Jun. 2, 2021, U.S. Provisional Application No. 63/211,290, filed Jun. 16, 2021, and U.S. Provisional Application No. 63/211,900 filed Jun. 17, 2021, the disclosures of each of which are incorporated, in their entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method for flexible scaling quality control with limited hardware resources by using an efficient scaler filter coefficients layout.

FIG. 2 is a block diagram of an exemplary coefficient table.

FIG. 3 is a block diagram of an exemplary codebase that accesses data.

FIG. 4 is a block diagram of an exemplary privacy-aware infrastructure.

FIG. 5 is a flow diagram of an exemplary computer-implemented method for establishing a privacy-aware infrastructure.

FIG. 6 is a block diagram of an exemplary privacy-aware infrastructure.

FIG. 7A is a flow diagram of an exemplary method for scalable, general-purpose, low-cost integer motion search.

FIG. 7B is a diagram of a reference window from a reference frame and a source block from a source frame.

FIG. 7C is a diagram of correspondences between the source block and the reference window.

FIG. 7D is a diagram of buffer usage while iterating through source pixels.

FIG. 7E is a diagram of mask bits.

FIG. 7F is a block diagram of an exemplary system for scalable, general-purpose, low-cost integer motion search.

FIG. 8A is a block diagram of an example system for rate-distortion optimization (RDO) that supports multiple codecs.

FIG. 8B is a block diagram of a primary RDO core that includes a primary plurality of transform units and a secondary RDO core that includes a secondary plurality of transform units as described herein.

FIG. 8C is a flow diagram of an example method for RDO that supports multiple codecs.

FIG. 9A is a block diagram of an example query in a globally distributed data warehouse architecture.

FIG. 9B is a block diagram of an example architecture for a globally distributed data warehouse.

FIG. 10A is a schematic representation of an exemplary satellite optical communication system in which systems and methods as discussed herein may be employed.

FIG. 10B is a block diagram of an exemplary free-space optical communication system.

FIG. 10C is a flow diagram of an exemplary method of providing FSO communication.

FIG. 11 is a block diagram of an exemplary system for a distributed database system.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

### Efficient Scaler Filter Coefficients Layout for Flexible Scaling Quality Control with Limited Hardware Resources

Digital images and videos are often encoded in a color space having multiple channels. For example, an RGB color space may have red (R), green (G), and blue (B) channels. A Y′CbCr color space may have a luma (Y′, e.g., brightness) channel and a CbCr (chroma, e.g., color and more specifically Cb as blue minus luma and Cr as red minus luma) channel. As digital images and videos are increasingly shared over the internet, the digital images and videos may need to be scaled (e.g., resized) for various reasons, such as reducing storage requirements, meeting bandwidth limitations, viewability on different screen sizes, etc.

When scaling images from one resolution (e.g., from an input image) to another resolution (e.g., to an output image), every output pixel of the output image may be calculated from a filtering operation between N input pixels and N filter coefficients. The filter coefficients may be different based on, for example, a scaling ratio between the input and output images, a phase, and/or an output pixel position. A brute force solution to scaling may require one filter set with N coefficients per output pixel per channel (e.g., luma channel and chroma channel). However, such a brute force solution may require a significant amount of on-chip memory, for instance, N*(A+B) per channel, where A and B are the output image height and width. For high output resolutions, such as 4K, 1K, etc., the memory requirements for coefficients may be prohibitively large.

The present disclosure is generally directed to an efficient scaler filter coefficients layout for flexible scaling quality control with limited hardware resources. As will be explained in greater detail below, embodiments of the present disclosure may generate a coefficient table including multiple index tables for multiple channels (e.g., a horizontal luma table, a horizontal chroma table, a vertical luma table, and a vertical chroma table). This combined coefficient table may provide flexibility for luma and chroma processing as well as horizontal and vertical processing. Using the combined coefficient table may reduce memory requirements and power consumption to make more efficient use of hardware resources.

Features from any of the embodiments described herein may be used in combination with one another in accordance with the general principles described herein. These and other embodiments, features, and advantages will be more fully understood upon reading the following detailed description in conjunction with the accompanying drawings and claims.

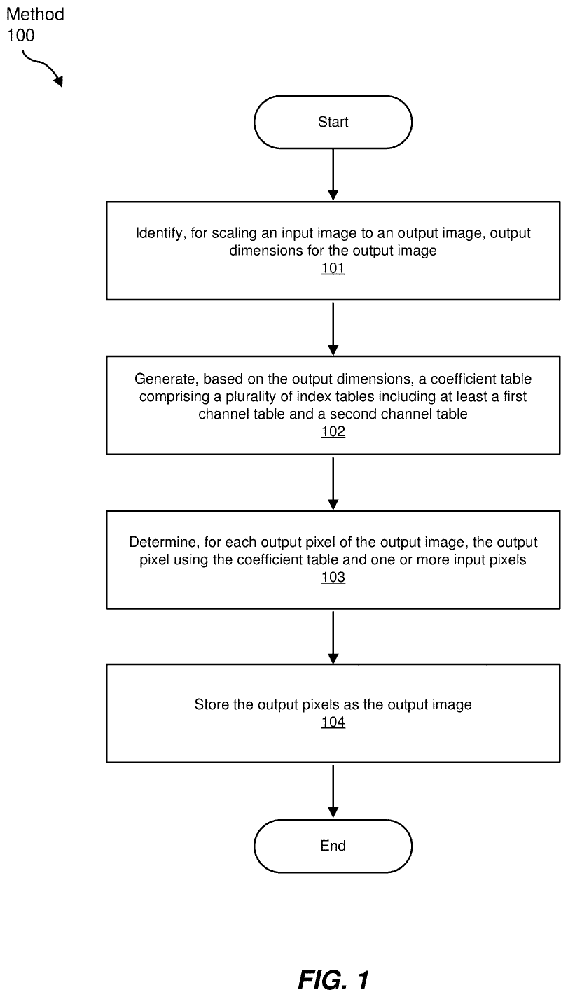

FIG. 1 is a flow diagram of an exemplary computer-implemented method 100 for flexible scaling quality control with limited hardware resources. The steps shown in FIG. 1 may be performed by any suitable computer-executable code and/or computing system. In one example, each of the steps shown in FIG. 1 may represent an algorithm whose structure includes and/or is represented by multiple sub-steps, examples of which will be provided in greater detail below.

As illustrated in FIG. 1, at step 101 one or more of the systems described herein may identify, for scaling an input image to an output image, output dimensions for the output image. For example, if the input image is to be upscaled to the output image, the output dimensions may be larger than input dimensions of the input image. Alternatively, if the input image is to be downscaled to the output image, the output dimensions may be smaller than the input dimensions.

At step 102 one or more of the systems described herein may generate, based on the output dimensions, a coefficient table comprising a plurality of index tables including at least a first channel table and a second channel table. For example, the first channel table may correspond to a first channel for the input and/or output images, such as luma. The second channel table may correspond to a second channel for the input and/or output images, such as chroma.

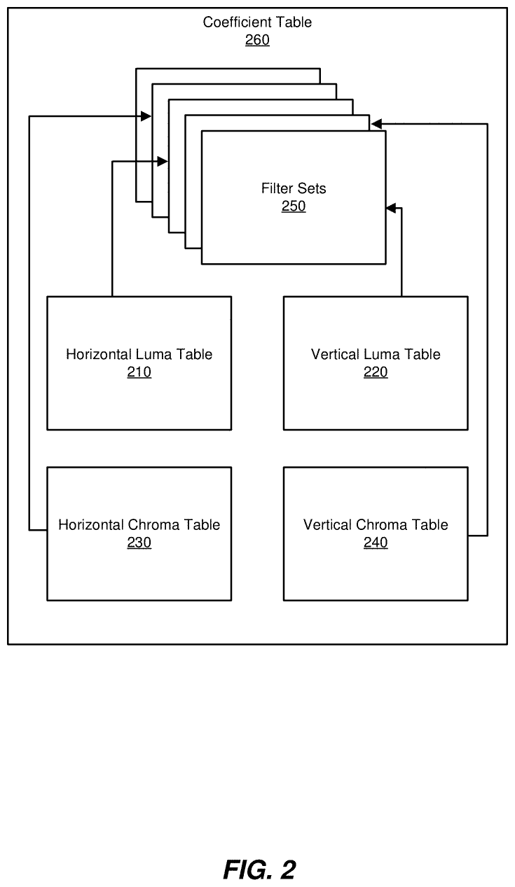

FIG. 2 illustrates a coefficient table 260. Coefficient table 260 may be a combined coefficient table including multiple index tables, namely a horizontal luma table 210, a vertical luma table 220, a horizontal chroma table 230, and a vertical chroma table 240.

Coefficient table 260 may correspond to a plurality of filter sets, which may be stored as filter sets 250. Filter sets 250 may include sets of filter coefficients for calculating output pixels of the output image, based on input pixels of the input image, such as a filter set for scaling from a first resolution to a second resolution. Coefficient table 260 may include the various filter sets 250, as well as index tables (e.g., horizontal luma table 210, vertical luma table 220, horizontal chroma table 230, and vertical chroma table 240) that may each point to any of the filter sets 250. In this way, coefficient table 260 may provide generality, particularly for challenging scaling ratios where an ideal number of filters may be greater than the coefficient table size. In some embodiments, an original number of filter sets may be quantized or otherwise compressed into a target number of filter sets for storing in the coefficient table.

The index tables (e.g., horizontal luma table 210, vertical luma table 220, horizontal chroma table 230, and vertical chroma table 240) may each be sized for their corresponding dimension and channel for the output image and may only contain the relevant indexes of coefficient table 260. For example, horizontal luma table 210 may be sized based on a horizontal output dimension and luma channel for the output image. Vertical luma table 220 may be sized based on a vertical output dimension and luma channel for the output image. Horizontal chroma table 230 may be sized based on the horizontal output dimension and chroma channel for the output image. Vertical chroma table 240 may be sized based on the vertical output dimension and chroma channel for the output image. In some embodiments, one or more of the index tables may comprise a pointer that may point to a specific filter set of filter sets 250 that may provide optimal quality for a given output pixel.

In some embodiments, coefficient table 260 may comprise a fast-table or regret rather than including index tables or requiring reads from a large coefficient table. When smaller sets of coefficients are used and/or the filter usage patterns are circular, for instance for common scaling ratios, the filter coefficients may be stored in a specialized data structure, which may realize additional power savings for common use cases.

Returning to FIG. 1, at step 103 one or more of the systems described herein may determine, for each output pixel of the output image, the output pixel using the coefficient table and one or more input pixels. Each output pixel may be calculated by transforming the corresponding input pixel(s) using the corresponding filter coefficients retrieved from the coefficient table. For example, based on the output pixel's location (e.g., along horizontal and vertical dimensions), the corresponding filter coefficients for each channel (e.g., luma and chroma) may be found in the index tables (e.g., by finding the filter coefficients for the output pixel's horizontal dimension value in horizontal luma table 210 and horizontal chroma table 230, and finding the filter coefficients for the output pixel's vertical dimension value in vertical luma table 220 and vertical chroma table 240).

At step 104 one or more of the systems described herein may store the determined output pixels as the output image. For example, the output image may comprise all the output pixels determined from the input pixels and coefficient filters as described herein.

The present disclosure provides a combined luma and chroma coefficient table with four separate index tables, one for horizontal luma, one for horizontal chroma, one for vertical luma, and one for vertical chroma. This combined coefficient table may allow elasticities in two aspects: between luma and chroma processing and between horizontal and vertical processing. The combined coefficient table may provide means for content driven filter coefficient allocation optimization by having separate index tables, each of which may be capable of addressing the entire space of the coefficient table. This arrangement may provide flexibility by having separate quality levels for the luma and chroma channels in both directions and may provide higher quality to content that the human visual system may be more sensitive to.

The combined coefficient table may also provide luma and chroma in both directions for an improvement in terms of the number of coefficient sets (and thus scaling quality) that the coefficient table may have access to. For instance, given the same hardware resources for common scaling use cases when coefficient sets are identical across directions and channels, the coefficient table may provide a 4× improvement.

### EXAMPLE EMBODIMENTS

Example 1: A computer-implemented method comprising: identifying, for scaling an input image to an output image, output dimensions for the output image; generating, based on the output dimensions, a coefficient table comprising a plurality of index tables including at least a first channel table and a second channel table; determining, for each output pixel of the output image, the output pixel using the coefficient table and one or more input pixels; and storing the determined output pixels as the output image.

Example 2: The method of Example 1, wherein the first channel table comprises a horizontal luma table, the second channel table comprises a horizontal chroma table, and the plurality of index tables further comprises a vertical luma table and a vertical chroma table.

Example 3: The method of Example 1 or 2, wherein the coefficient table corresponds to a plurality of filter sets.

Example 4: The method of Examples 1-3, wherein each of the plurality of index tables includes a pointer to one or more of the plurality of filter sets.

Example 5: The method of Examples 1-4, further comprising quantizing the plurality of filter sets to a target number of filter sets for storing in the coefficient table.

Example 6: The method of any of Examples 1-5, wherein the coefficient table comprises a fast-table.

Example 7: The method of Examples 1-6, wherein the fast-table corresponds to a common scaling ratio.

### Privacy-Aware Infrastructure

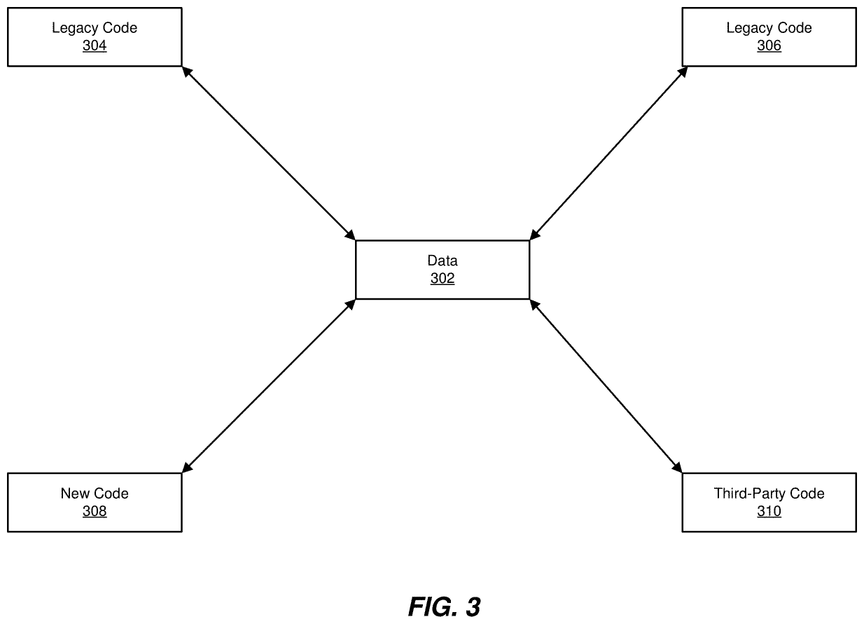

Updating existing software and deploying new software may require compliance with a large number of fast-changing regulatory guidelines in relation to data privacy. In some cases, uncategorized data and complex infrastructure may make complying with privacy regulations difficult and time-consuming as data may be manually tracked through the lifecycle and/or code may be manually double-checked to ensure that no data is accessed improperly. For example, as illustrated in FIG. 3, data 302 may be accessed by legacy code 304, legacy code 306, new code 308, and/or third-party code 310, all of which must comply with constantly evolving privacy regulations. By categorizing all data according to a universal taxonomy and creating a privacy layer that enforces the privacy policy on any code that interacts with data, the systems and methods described herein may increase the efficiency of managing large-scale amounts of data in complex codebases in accordance with privacy regulations.

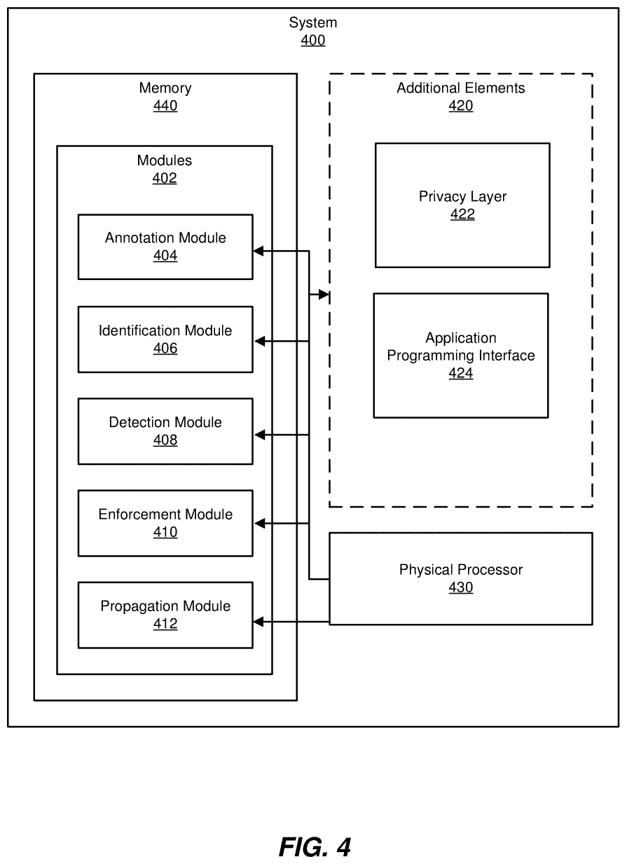

FIG. 4 shows a block diagram of an exemplary system 400 for a privacy-aware infrastructure. As illustrated in this figure, system 400 may include one or more modules 402 for performing one or more tasks and/or one or more additional elements 420. For example, and as will be explained in greater detail below, system 400 may include an annotation module 404 that annotates stored data with a privacy policy such that each subset of the stored data is annotated with a subset of the privacy policy that applies to the subset of the stored data. System 400 may additionally include an identification module 406 that identifies a privacy layer 422 that enforces the privacy policy on all application programming interfaces that interact with the stored data. System 400 may also include a detection module 408 that detects that an application programming interface (API) 424 is interacting with a subset of the stored data. System 400 may additionally include an enforcement module 410 that enforces, by privacy layer 422, the subset of the privacy policy that applies to the subset of the stored data. System 400 may also include a propagation module 412 that propagates, by API 424, a privacy context relevant to the subset of the privacy policy as part of interacting with the subset of the stored data. Although illustrated as separate elements, one or more of modules 402 in FIG. 4 may represent portions of a single module or application.

In certain embodiments, one or more of modules 402 in FIG. 4 may represent one or more software applications or programs that, when executed by a computing device, may cause the computing device to perform one or more tasks. For example, and as will be described in greater detail below, one or more of modules 402 may represent modules stored and configured to run on one or more computing devices. One or more of modules 402 in FIG. 4 may also represent all or portions of one or more special-purpose computers configured to perform one or more tasks.

As illustrated in FIG. 4, system 400 may also include one or more memory devices, such as memory 440. Memory 440 generally represents any type or form of volatile or non-volatile storage device or medium capable of storing data and/or computer-readable instructions. In one example, memory 440 may store, load, and/or maintain one or more of modules 402. Examples of memory 440 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 4, system 400 may also include one or more physical processors, such as physical processor 430. Physical processor 430 generally represents any type or form of hardware-implemented processing unit capable of interpreting and/or executing computer-readable instructions. In one example, physical processor 430 may access and/or modify one or more of modules 402 stored in memory 440. Additionally or alternatively, physical processor 430 may execute one or more of modules 402 to facilitate retrieving driver safety scores by passenger devices. Examples of physical processor 430 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

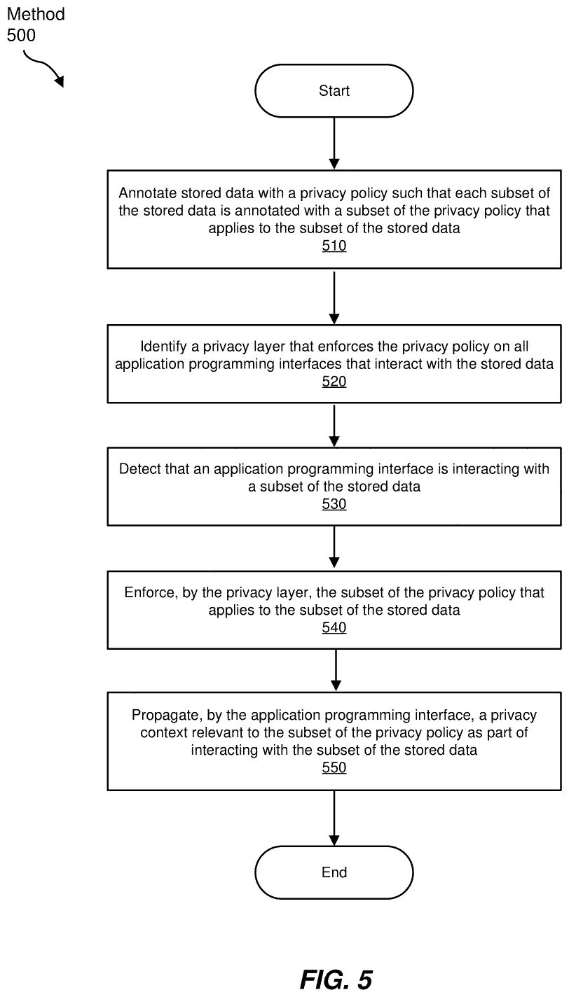

FIG. 5 is a flow diagram of an exemplary computer-implemented method 500 for establishing a privacy-aware infrastructure. The steps shown in FIG. 5 may be performed by any suitable computer-executable code and/or computing system, including system 400 illustrated in FIG. 4. In one example, each of the steps shown in FIG. 5 may represent an algorithm whose structure includes and/or is represented by multiple sub-steps, examples of which will be provided in greater detail below.

As illustrated in FIG. 5, at step 510, one or more of the systems described herein may annotate stored data with a privacy policy such that each subset of the stored data is annotated with a subset of the privacy policy that applies to the subset of the stored data. For example, annotation module 404 may annotate stored data with a privacy policy such that each subset of the stored data is annotated with a subset of the privacy policy that applies to the subset of the stored data.

In some embodiments, annotation module 404 may annotate the stored data with the privacy policy by schematizing the stored data with a unified data taxonomy and associating each category of the unified data taxonomy with a relevant subset of the privacy policy. In some examples, the systems described herein may classify data according to the type of privacy regulations that apply to the data and/or the type of the data. For example, the systems described herein may classify data as personally identifying information, financial information, health information, non-sensitive information, and so forth.

In some examples, annotation module 404 may annotate the stored data with the privacy policy by integrating the stored data with an end-to-end data lineage graph. For example, the systems described herein may track interactions between code and data via the end-to-end data lineage graph in order to document that no privacy regulations have been breached in the handling of the data.

In one embodiment, the systems described herein may identify code that is not annotated with privacy context derived from the privacy policy and annotate the code with the privacy context. In some examples, the systems described herein may flag newly-added code that does not yet have an associated privacy context. Additionally or alternatively, the systems described herein may analyze a codebase of existing code to automatically flag code without an associated privacy context. Examples of privacy context may include the purpose of the code, the data that the code is expected to interact with, one or more developers associated with the code, and/or the sections of the privacy policy that are relevant to the code.

At step 520, one or more of the systems described herein may identify a privacy layer that enforces the privacy policy on all application programming interfaces that interact with the stored data. For example, identification module 406 may identify privacy layer 522 that enforces the privacy policy on all APIs that interact with the stored data. In some examples, privacy layer 522 may enforce the privacy policy by preventing an API from accessing certain data and/or transmitting certain data.

At step 530, one or more of the systems described herein may detect that an API is interacting with a subset of the stored data. For example, detection module 408 may detect that API 524 is interacting with a subset of the stored data. In some examples, detection module 408 may detect that API 524 is attempting to access the data, copy the data, move the data, and/or delete the data.

At step 540, one or more of the systems described herein may enforce, by the privacy layer, the subset of the privacy policy that applies to the subset of the stored data. For example, enforcement module 410 may enforce, by privacy layer 522, the subset of the privacy policy that applies to the subset of the stored data. In some examples, enforcement module 410 may enforce the privacy policy by enabling API 524 to interact with the stored data. Additionally or alternatively, enforcement module 410 may modify how API 524 interacts with the data, for example by redacting a portion of the data, attaching additional privacy information to the data, and/or recording the interaction.

At step 550, one or more of the systems described herein may propagate, by the API, a privacy context relevant to the subset of the privacy policy as part of interacting with the subset of the stored data. For example, propagation module 412 may propagate, by API 524, a privacy context relevant to the subset of the privacy policy as part of interacting with the subset of the stored data. In one example, propagation module 412 may copy privacy-related annotations attached to the data. Additionally or alternatively, propagation module 412 may propagate a privacy context associated with the code being called by API 524. In one embodiment, propagation module 412 may propagate the privacy context by updating the end-to-end data lineage graph with information about the API interacting with the subset of the stored data.

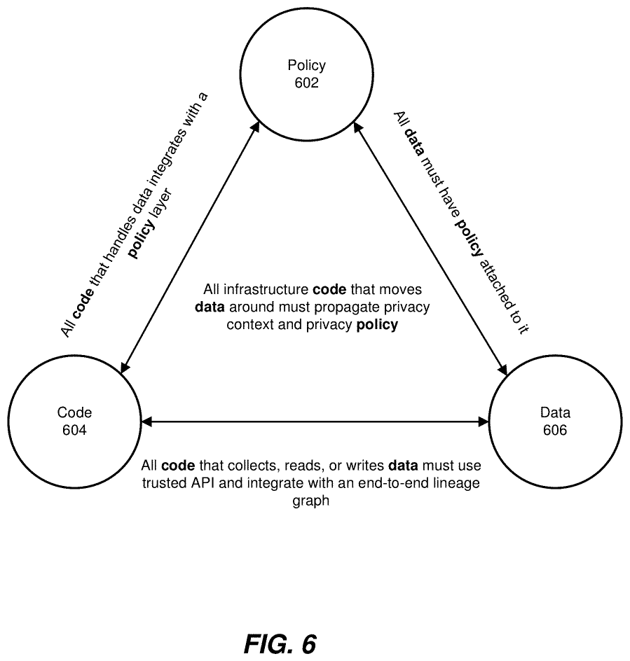

FIG. 6 is a diagram of an exemplary system for a privacy-aware infrastructure. As illustrated in FIG. 6, a system for a privacy-aware infrastructure may include a policy 602, code 604, and/or data 606. In some embodiments, policy 602 may include a variety of defined subsections of privacy policy that each correspond to one or more privacy regulations and/or one or more types of data within data 606. In one embodiment, all code 604 that collects, reads, or writes data may have a privacy context attached to it in accordance with policy 602. In some embodiments, all data 606 may be schematized in order to enable accurate enforcement of policy 602. In one embodiment, all infrastructure code that moves data around may propagate privacy context and privacy policy. In some embodiments, if all code that handles data integrates with a policy layer, all data has a policy attached to it, and all code that collects, reads, or writes data uses a trusted API and integrates with an end-to-end lineage graph, the systems described herein may efficiently enforce privacy policies on large data sets across complex and evolving codebases.

### EXAMPLE EMBODIMENTS

Example 8: A method for privacy-aware infrastructure may include (i) annotating stored data with a privacy policy such that each subset of the stored data is annotated with a subset of the privacy policy that applies to the subset of the stored data, (ii) identifying a privacy layer that enforces the privacy policy on all application programming interfaces that interact with the stored data, (iii) detecting that an application programming interface is interacting with a subset of the stored data, (iv) enforcing, by the privacy layer, the subset of the privacy policy that applies to the subset of the stored data, and (v) propagating, by the application programming interface, a privacy context relevant to the subset of the privacy policy as part of interacting with the subset of the stored data.

Example 9: The computer-implemented method of example 8, wherein propagating, by the application programming interface, the privacy context comprises propagating the subset of the privacy policy.

Example 10: The computer-implemented method of examples 8 or 9, wherein the application programming interface comprises a trusted application programming interface.

Example 11: The computer-implemented method of examples 8-10, wherein enforcing the privacy policy comprises preventing the application programming interface from transmitting the subset of the stored data.

Example 12: The computer-implemented method of examples 8-11, wherein enforcing the privacy policy comprises preventing the application programming interface from accessing the subset of the stored data.

Example 13: The computer-implemented method of examples 8-12, where annotating the stored data with the privacy policy may include schematizing the stored data with a unified data taxonomy and associating each category of the unified data taxonomy with a relevant subset of the privacy policy.

Example 14: The computer-implemented method of examples 8-13 may further include identifying code that is not annotated with privacy context derived from the privacy policy and annotating the code with the privacy context.

Example 15: The computer-implemented method of examples 8-14, where annotating the stored data with the privacy policy includes integrating the stored data with an end-to-end data lineage graph.

Example 16: The computer-implemented method of examples 8-15, where propagating, by the application programming interface, the privacy context includes updating the end-to-end data lineage graph with information about the application programming interface interacting with the subset of the stored data.

### Scalable General-Purpose Low-Cost Integer Motion Search

Various image and video processing techniques and architectures may rely on motion search. For example, video encoders, computer vision, etc. may use motion search for detecting movement of objects between video frames. This movement of objects may be determined by recognizing that a particular group of pixels (e.g., the object) has shifted locations between frames.

Motion search may be performed using a blockmatching scheme to recognize object movement. Pixels of a current frame (e.g., a source frame) may be compared to pixels of a second frame (e.g., a reference frame) that may come before or after the current frame. The pixels of the source frame may be subdivided into a block of pixels (e.g., source block). The reference frame may be searched to find a match for the source block. The match may be determined by a block of pixels—having a same block size as that of the source block—matching to the source block within an acceptable error threshold. The error between the source block and a block of pixels from the reference frame may be calculated, for example, by calculating a mean squared error (“MSE”), sum of squared errors (SSE), sum of absolute differences (“SAD”) or other method. If a matching block is found, a location of the matching block in the reference frame may be compared to a location of the source block in the source frame to determine a motion vector for the source block.

Finding the matching block may involve comparing the source block to various blocks from the reference frame. However, comparing the source block to every possible block (e.g., every contiguous grouping of pixels having the block size) may be computationally expensive and time consuming. Because of a low likelihood of the source block having moved significantly across the frame between nearby frames, searching the entire reference frame may not be necessary. Thus, to improve performance, only a subset of pixels of the reference frame (e.g., a reference window) may be searched. The reference window may be determined by identifying pixels having the same location in the reference frame as the source block in the source frame and including neighboring pixels in the reference frame within a specified distance. Therefore, the reference window may be larger than the source block.

However, even with reducing the search window, motion search may require intensive calculations along with a large external and on-chip memory bandwidth. For example, if the reference window pixels were initially stored in a line buffer, the motion search may require fetching reference window pixels numerous times, which may require costly memory bandwidth.

The present disclosure is generally directed to a scalable, general-purpose, low-cost integer motion search. As will be explained in greater detail below, embodiments of the present disclosure may partition a source block of pixels from a source frame into source grids and a reference window of pixels from a reference frame into reference grids, and iterate through the source grids by reading from a first reference grid corresponding to a current dimension value of the source grid from a reference buffer along with a second reference grid corresponding to a prior dimension value of the source grid from a local reference buffer. After performing calculations with respect to the current source grid, the first reference grid may replace the second reference grid in the local reference buffer. Thus, each reference grid may be fetched only once from the reference buffer to improve memory bandwidth and reduce power consumption.

Features from any of the embodiments described herein may be used in combination with one another in accordance with the general principles described herein. These and other embodiments, features, and advantages will be more fully understood upon reading the following detailed description in conjunction with the accompanying drawings and claims.

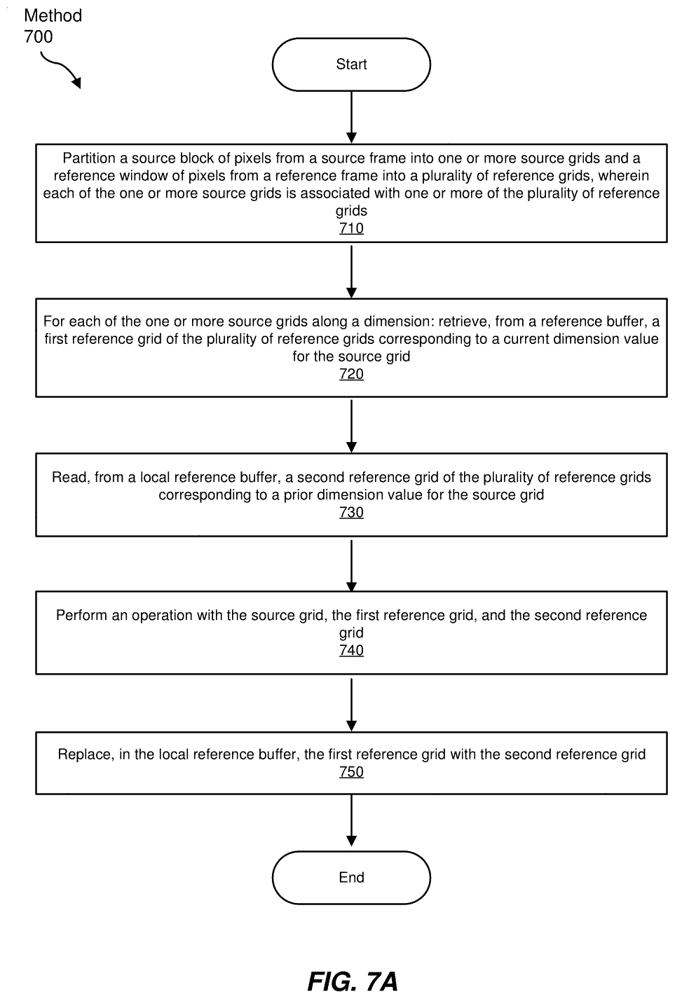

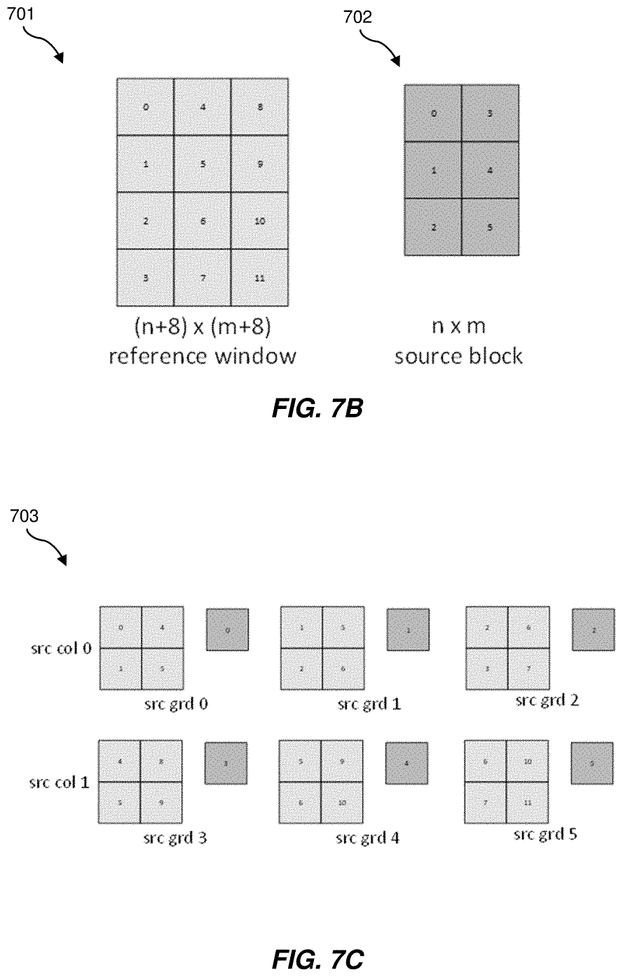

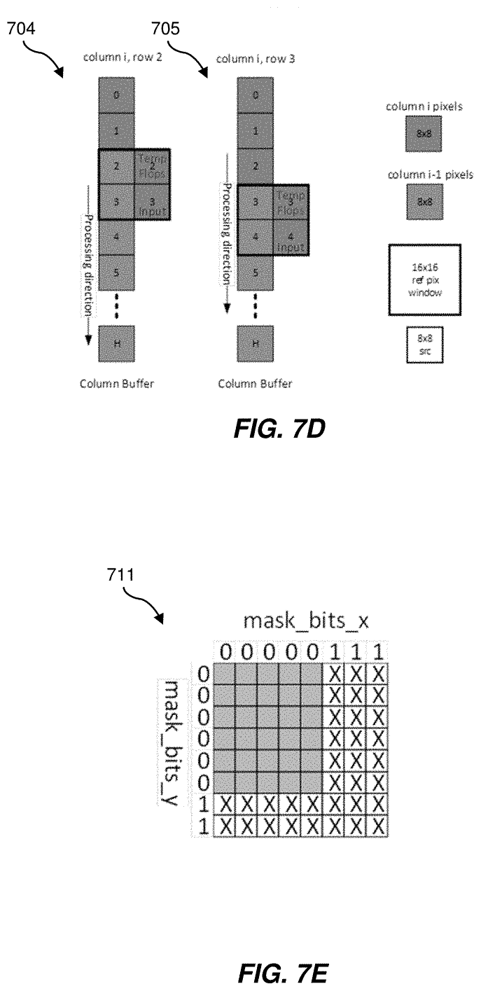

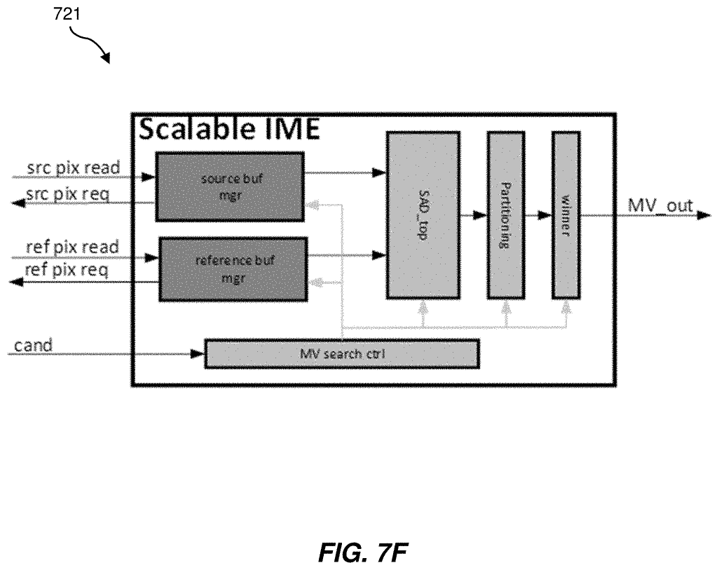

FIG. 7 is a flow diagram of an exemplary computer-implemented method 700 for scalable, general-purpose, low-cost integer motion search. The steps shown in FIG. 7 may be performed by any suitable computer-executable code and/or computing system, including the system(s) illustrated in FIG. 7F which will be described further below. In one example, each of the steps shown in FIG. 7 may represent an algorithm whose structure includes and/or is represented by multiple sub-steps, examples of which will be provided in greater detail below.

As illustrated in FIG. 7A, at step 710 one or more of the systems described herein may partition a source block of pixels from a source frame into one or more source grids and a reference window of pixels from a reference frame into a plurality of reference grids. Each of the one or more source grids may be associated with one or more of the plurality of reference grids. For example, FIG. 7B shows one example of partitioning a reference window 701 and a source block 702.

As shown in FIG. 7B, source block 702 may have a size of n×m (e.g., 16×24 pixels) and reference window 701 may have a size of (n+8)×(m+8) (e.g., 24×32 pixels) that is greater than that of source block 702. Using the same grid size of 8×8 pixels, reference window 701 may have 12 reference grids (numbered 0-11) and source block 702 may have 6 source grids (numbered 0-5). Although the examples herein are described with respect to 8×8 grid sizes, in other embodiments other block sizes, grid sizes, reference window sizes (e.g., search window sizes), etc. may be used.

FIG. 7C shows a diagram 703 of associations between the source grids of source block 702 and the reference grids of reference window 701. More specifically, source grid 0 may be searched against reference grids 0, 4, 1, and 5, source grid 1 may be searched against reference grids 1, 2, 5, and 6, and so forth.

Returning to FIG. 7A, at step 720 one or more of the systems described herein may, for each of the one or more source grids along a dimension, retrieve, from a reference buffer, a first reference grid of the plurality of reference grids corresponding to a current dimension value for the source grid. For example, the source grids may be processed in a vertical order (e.g. by column as the dimension) or horizontal order (e.g., by row as the dimension).

FIG. 7C shows how the source grids may be iterated through by column. For example, source column 0 may include source grid 0, 1, and 2, and source column 1 may include source grid 3, 4, and 5. Reference columns 0 and 1 may correspond to source column 0 and reference columns 1 and 2 may correspond to source column 1. Thus, to process source column 0, reference columns 0 and 1 may be needed. More specifically, to process source grid 0, reference grids 0 and 1 from reference column 0 and reference grids 4 and 5 from reference column 1 may be needed.

Although the reference grids may be stored in a reference buffer, repeated retrieving from the reference buffer may negatively affect performance. As will be further described below, rather than fetching both reference column 0 (e.g., reference grids 0 and 1) and reference column 1 (e.g., reference grids 4 and 5) from the reference buffer, only reference column 1 may be fetched from the reference buffer. Moreover, after initialization and population of local buffers (e.g., populating a local reference buffer with reference grids 0-3 of reference column 0 and temporarily holding reference grid 4), only a single reference grid (e.g., reference grid 5) may be retrieved as a new input. Thus, a reference grid from reference column 1, corresponding to the current dimension value for source grid 0, may be retrieved from the reference buffer.

At step 730 one or more of the systems described herein may read, from a local reference buffer, a second reference grid of the plurality of reference grids corresponding to a prior dimension value for the source grid. For example, when processing source grid 0, reference grids 0 and 1 may be read from the local reference buffer. Thus, a reference grid from reference column 0, corresponding to the prior dimension value for source grid 0, may be read from the local reference buffer to avoid another retrieval from the reference buffer. The local reference buffer may, for example, be an on-chip buffer having less overhead for read operations compared to that of the reference buffer.

At step 740 one or more of the systems described herein may perform an operation with the source grid, the first reference grid, and the second reference grid. For example, processing the source grid (e.g., source grid 0) may include performing an operation (e.g., SAD calculation) with the source grid (e.g., source grid 0), the first reference grid (e.g., reference grid 0), the second reference grid (e.g., reference grid 4), along with additional reference grids (e.g., reference grids 1 and 5).

At step 750 one or more of the systems described herein may replace, in the local reference buffer, the first reference grid with the second reference grid. For example, the second reference grid (e.g., reference grid 4) may replace the first reference grid (e.g., reference grid 0) in the local reference buffer.

As seen in FIG. 7C, after processing source grid 0, reference grid 0 may no longer be needed for processing. However, source grid 3, being in the same row as source grid 0 but having a next column value, may require reference grid 4 for processing. Thus, by replacing reference grid 0 with reference grid 4 may avoid an additional fetch from the reference buffer by discarding a reference grid that may no longer be needed. Reference grid 1 may remain in the local reference buffer as it may be needed for processing another source grid (e.g., source grid 1).

For instance, when processing source grid 1, reference grids 1, 2, 5, and 6 may be needed. Reference grids 1 and 2 may be read from the local reference buffer. Reference grid 5 may be temporarily held over from processing source grid 0, such that only reference grid 6 may need to be retrieved from the reference buffer. Once source grid 1 is processed, reference grid 5 may replace reference grid 1 (which may no longer be needed) in the local reference buffer. Thus, when source grid 3 is processed, reference grids 4 and 5 may have been retained in the local reference buffer.

FIG. 7D illustrates how a local reference buffer (e.g., a column buffer 704 and a column buffer 705) may be updated. Column buffer 704 and 705 may have a width corresponding to a single grid width, and a height of a number of grid rows in a corresponding reference window. In other embodiments (e.g., when iterating though rows), the local reference buffer may have a corresponding width of a number of grid columns and a height of a single grid.

As shown in FIG. 7D, as a reference pixel window (e.g., corresponding to four 8×8 source grids) is processed for an associated source grid of column i, column buffer 704 and 705 may hold reference grids of column i−1. For a current source grid of column i and row (e.g., row 2 with respect to column buffer 704), a reference grid of the current column i and current row 2 may have been held in temp flops from processing the previous source grid (e.g., current row-1) and a reference grid of the current column i and next row (e.g., row 3 with respect to column buffer 704) may be retrieved from a reference buffer as a new input. Thus, with respect to column buffer 705, processing a source grid of column i, row 3, only a reference grid of the current column i and next row (e.g., 4) may be retrieved from the reference buffer. As the source grids and reference grids are processed along the processing directing (e.g., down a column), reference grids of column i−1 may be replaced with reference grids of column i. Thus, when processing column i+1, column buffers 704 and 705 may store the reference grids of column i that may be needed.

In some embodiments, a smaller search window size than that of a grid size may be needed. FIG. 7E illustrates a mask 711 having the grid size but may be used for searching the smaller search window size. Enabled mask bits (e.g., a right 3 columns and bottom 2 rows in mask 711) may be used to reduce the search window size. Thus, mask 711 may allow searching 5×6 pixels instead of 8×8. In other words, only pixels without enabled mask bits may be searched.

FIG. 7F illustrates a basic circuit diagram of a processor such as a management engine or microcontroller coprocessor that may be configured for motion search. SAD_top may be a general-purpose circuit that may dispatch 16×16 reference pixels (e.g., four reference grids) and 8×8 source pixels (e.g., one source grid) to a corresponding 4×4 SAD calculation unit. Although additional 4×4 SAD calculation units may run faster, power consumption may increase. A number of 4×4 SAD calculation units may be determined by a usage model and performance requirement. A portioning unit may accumulate search costs for different prediction units based on the usage model. A winner unit may find a final winner (e.g., match) for the entire search window.

As described herein, motion search may be a key feature in video encoders, computer vision and image processing. Motion search may require intensive calculations as well as huge external and on-chip memory bandwidth. Motion search may consume significant power and therefore having a favorable trade-off between performance, quality, and low power consumption in designing a high-end integer motion search circuit may be difficult.

As described herein, a general-purpose, low-cost integer motion search with a column buffer may guarantee that all the reference pixels are fetched from the local line buffer once for significant savings in power consumption. This general-purpose search engine may use 8×8=32 search points for a source size of 8×8. This engine may use up to 256 SAD calculation units to finish the task in one cycle. A number of SAD units may depend on the usage model and performance requirement.

This general-purpose engine may be applied to video encoders, computer vision (“CV”) and imaging processing. It may support different block sizes with the corresponding partition logic to simplify design with easy expansion to support an arbitrary search window size.

This engine may include scalable features to partition the arbitrarily large search window into multiple 8×8 search windows and to apply the general-purpose search engine to these 8×8 search windows to find a final winner (e.g., best match) for the arbitrary large search window.

The solution may use a moving window strategy to guarantee one fetch of the reference window for each 8×8 search. The solution may include, for instance: 1) partitioning a source block (w×h) and a reference window (w+8)×(h+8) into 8×8 grids. For example, using w=16, and h=24, a source block size may have 6 8×8 grids, and its corresponding 8×8 search window may have 24×32 references pixels, or in 12 8×8 grids. (See, e.g., FIGS. 7B and 7C). There are two ways to loop through these 2D grids: vertical order or horizontal order. The vertical order is described herein for demonstration purposes.

A one column buffer solution is provided herein. In this example, a column may refer to 8-pixel width. FIG. 7D shows how to update the column buffer to get one source 8×8 grid done. After the operation, the column i pixel 8×8 block 2 may be pushed into the column buffer for the next source column grid search. With this approach, all reference pixels may be only fetched once from local line buffer memory to achieve power savings and save local memory bandwidth by using the small local column buffer. Only 8 pixels wide column buffer may be needed. The column buffer size may be max block height+8.

The innovation may be transparent and able to support scalable motion search blindly with the control info last bits passed down through the pipeline. The winner stage blindly generates the final search winner based on the last bits.

In FIG. 7F, SAD_top may be a general purpose circuit to dispatch 16×16 reference pixels and 8×8 source pixels to the corresponding generic 4×4 SADs calculation unit. If more 4×4 SADs calculation units are used, the system may consume more power yet run faster. The real number of 4×4 SADs used may be decided by the usage model and performance requirement.

The partitioning unit may accumulate the search costs for the different prediction unit based on the usage model. The winner unit may find the final winner for the entire search window.

This innovation is described herein based on an 8×8 search window. For a smaller size search window after grid partitioning (e.g., right and bottom grids), FIG. 7E shows the mask bits to cull the points not searched from finding the winner. The mask has 8 mask bits in the X direction and 8 mask bits in the Y direction. For example, if mask_bits_x=0 0 0 0 0 1 1 1, there are 3 search column points in right that are illegal, and if mask_bits_y=0 0 0 0 0 0 1 1, there are 2 rows in the bottom that are illegal. The illegal search points are marked with X in FIG. 7E.

### EXAMPLE EMBODIMENTS

Example 17. A computer-implemented method comprising: partitioning a source block of pixels from a source frame into one or more source grids and a reference window of pixels from a reference frame into a plurality of reference grids, wherein each of the one or more source grids is associated with one or more of the plurality of reference grids; and for each of the one or more source grids along a dimension: retrieving, from a reference buffer, a first reference grid of the plurality of reference grids corresponding to a current dimension value for the source grid; reading, from a local reference buffer, a second reference grid of the plurality of reference grids corresponding to a prior dimension value for the source grid; performing an operation with the source grid, the first reference grid, and the second reference grid; and replacing, in the local reference buffer, the first reference grid with the second reference grid.

Example 18. The method of Example 17, wherein the dimension corresponds to a column or a row.

Example 19. The method of Examples 17 or 18, wherein each of the one or more source grids and each of the plurality of reference grids have a same grid size.

Example 20. The method of any of Examples 17-19, wherein a size of the reference window is greater than a size of the source block.

Example 21. The method of any of Examples 17-20, further comprising applying one or more mask bits to reduce a grid size.

### A Hardware Pipeline for RDO that Supports Multiple Codecs

Modern video encoding standards, such as H.264/Advanced Video Coding (AVC) and VP9, are generally based on hybrid coding frameworks that may compress video data by exploiting redundancies within the video data. Compression may be achieved by identifying and storing only differences within the video data, such as may occur between temporally proximate frames (i.e., inter-frame coding) and/or between spatially proximate pixels (i.e., intra-frame coding). Inter-frame compression uses data from one or more earlier or later frames in a sequence to describe a current frame. Intra-frame coding, on the other hand, uses only data from within the current frame to describe the current frame.

Modern video encoding standards may additionally employ compression techniques like quantization that may exploit perceptual features of human vision, such as by eliminating, reducing, and/or more heavily compressing aspects of source video data that may be less relevant to human visual perception than other aspects. For example, as human vision may generally be more sensitive to changes in brightness than changes in color, a video encoder using a particular video codec may use more data to encode changes in luminance than changes in color. In all, video encoders must balance various trade-offs between video quality, bit rate, processing costs, and/or available system resources to effectively encode and/or decode video data.

Conventional or traditional methods of making encoding decisions may involve simply choosing a result that yields the highest quality output image according to some quality standard. However, such methods may choose settings that may require more bits to encode video data while providing comparatively little quality benefit. As an example, during a motion estimation portion of an encoding process, adding extra precision to representation of motion vectors of blocks might increase quality of an encoded output video, but the increase in quality might not be worth the extra bits necessary to encode the motion vectors with a higher precision.

As an additional example, during a basic encoding process, an encoder may divide each frame of video data into processing units. Depending on the codec, these processing units may be referred to as macroblocks (MB), coding units (CU) and/or coding tree units (CTU). Modern codecs may select a particular mode (i.e., a processing unit size and/or shape) from among several available modes for encoding video data. This mode decision may greatly impact an overall rate-distortion result for a particular output video file.

In order to determine or decide an optimal bit rate having an acceptable level of distortion, some modern codecs may use a technique called Lagrangian rate-distortion optimization (RDO). Generally, in an RDO process, a video encoder determines a cost value for each possible encoding parameter (e.g., intra prediction modes, macroblock coding modes, transform coefficient levels, etc.) and selects a parameter with the lowest cost. The video encoder must compute cost values for all possible parameters, resulting in RDO having a high computational burden.

Some systems may attempt to offload some of this high computational burden to specialized hardware. Unfortunately, different video codecs may support different modes and/or may employ different techniques for analyzing and/or encoding video data. Consequently, there may be a high cost of redundancy in such specialized RDO hardware, particularly when that specialized hardware may need to support multiple codecs. This redundancy may result in hardware complexity and high power usage. Hence, the instant application identifies and addresses a need for a power-efficient hardware pipeline for RDO that may support multiple different video codecs.

The present disclosure is generally directed to a power-efficient hardware pipeline for rate-distortion optimization (RDO) that supports multiple codecs. As will be explained in greater detail below, embodiments of the instant disclosure may include an input packet processing module in a video encoding hardware pipeline that receives an input packet for video encoding. Embodiments may also include one or more clock gating circuits that may generate a control signal. The control signal may include a primary signal or a secondary signal.

Embodiments may also include a primary rate-distortion optimization (RDO) core within the video encoding pipeline. The primary RDO core may, when the control signal includes the primary signal, adjust a bit rate of an encoding, in accordance with a primary video codec, of the input packet. Furthermore, the primary ROD core may, when the control signal includes the secondary signal, remain inactive within the video encoding pipeline. In some examples, the primary video codec may include an Advanced Video Coding (AVC/H.264) codec.

In some embodiments, a disclosed system may also include a secondary RDO core within the video encoding hardware pipeline that, when the control signal includes the secondary signal, adjusts a bit rate of an encoding, in accordance with a secondary video codec, of the input packet. Likewise, the secondary RDO core may, when the control signal includes the primary signal, remain inactive within the video encoding pipeline. In some examples, the secondary video codec may include a VP9 codec.

Therefore, some embodiments of the disclosed systems and methods may share the input packet processing module, but may activate and/or deactivate each RDO core depending on whether the video encoding hardware pipeline is encoding the input packet via the primary video codec or the secondary video codec. Hence, the unused RDO core may be deactivated when not in use, saving electrical power resources. This may be particularly relevant within a large-scale server environment where chip size or complexity may be less of a concern than efficient electrical power usage.

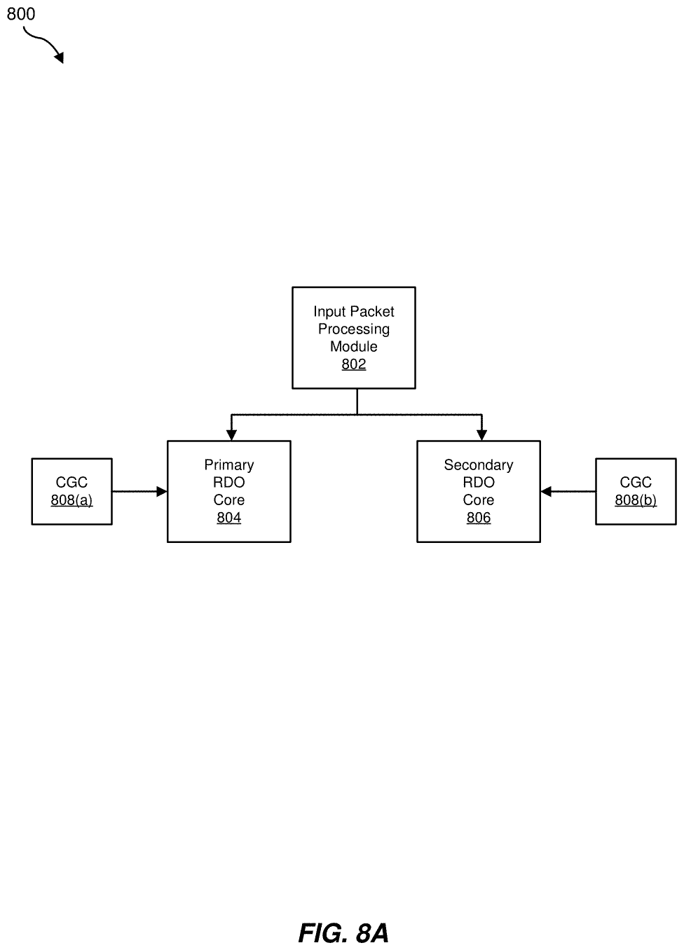

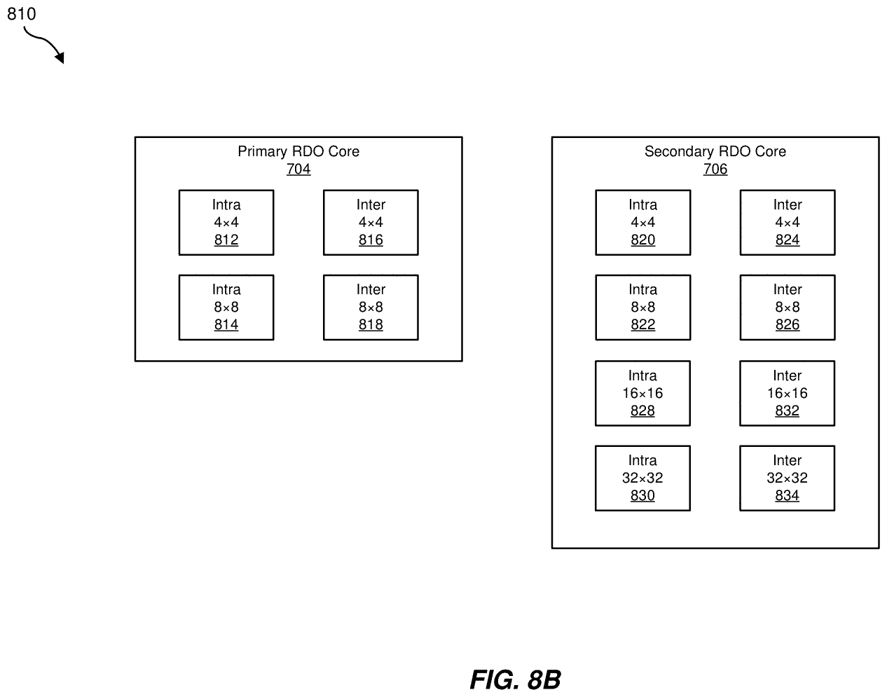

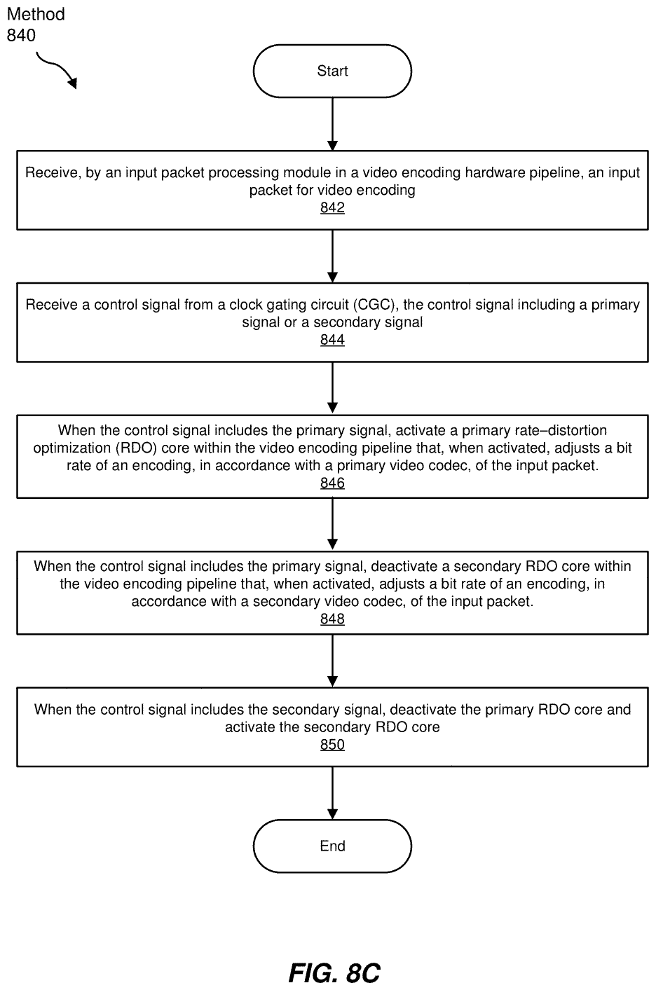

The following will provide, with reference to FIGS. 8A-8B, detailed descriptions of a power-efficient hardware pipeline for RDO that supports multiple codecs. Detailed descriptions of corresponding computer-implemented methods will also be provided in connection with FIG. 8C.

FIG. 8A is a block diagram of an example system 800 for a power-efficient hardware pipeline for rate-distortion optimization (RDO) that supports multiple codecs. As illustrated in this figure, example system 800 may include an input packet processing module 802 that may be communicatively coupled to a primary RDO core 804 and a secondary RDO core 806. As also shown, each RDO core may receive a control signal from a CGC 808. Specifically, primary RDO core 804 may receive a control signal from CGC 808(a) and secondary RDO core 806 may receive a control signal from CGC 808(b). Although shown as separate elements in FIG. 8A, CGC 808(a) and CGC(b) may represent a single CGC that may generate a control signal and may communicate the control signal to primary RDO core 802 and/or secondary RDO core 804 as described herein.

Input packet processing module may include any suitable hardware or software to receive input of video data packets from a suitable data source (e.g., a data store, another portion of a video encoding hardware pipeline, etc.) and to communicate the received data packets to one of primary RDO core 804 and secondary RDO core 806.

Additionally or alternatively, input packet processing module 802 may also receive and/or communicate to one or more of primary RDO core 806 and/or secondary RDO core 806 one or more sequence parameter sets (SPS) and/or picture parameter sets (PPS). As may be known in the art, sequence parameter sets (SPSs) may be used to signal infrequently changing parameters for a sequence of pictures, and picture parameter sets (PPSs) may be used to signal infrequently changing parameters for individual pictures. The RDO cores may use these parameters in adjusting a bit rate of an encoding of one or more input packets.

Each RDO core (e.g., primary RDO core 804 and/or secondary RDO core 806) may be configured to execute one or more operations associated with adjusting a bit rate of a video encoding of an input packet received by the respective RDO core from input module 802. As mentioned above, different encoding parameters may have differing rate-distortion characteristics, and the goal of a video encoding pipeline may be to minimize distortion D subject to a constraint R_{c} on a number of bits used R. This constraint problem may be represented as:

min{D}, subject to R<R_{c}.

This optimization task may be solved by using Lagrangian optimization where a distortion term is weight against a rate term. A Lagrangian formulation of the minimization problem may be:

min{J}, where J=D+λ×R,

where the Lagrangian rate-distortion function J may be minimized for a particular value of the Lagrange multiplier λ. Each solution for a given value of Lagrange multiplier λ corresponds to an optimal solution for a particular value of R_{c}.

Each RDO core may be configured to adjust a bit rate of an encoding of an input packet using these RDO principles, particularly in the use of motion estimation and prediction mode decisions. As each video codec may utilize different encoding parameters and may have different rate-distortion characteristics, each of the RDO cores in the present system may be configured to execute RDO operations in accordance with a different video codec. For example, primary RDO core 804 may be configured to execute RDO operations associated with an AVC/H.264 codec, whereas secondary RDO core 806 may be configured to execute RDO operations associated with a VP9 codec.

Additionally, in some examples, to further save power, each RDO core may include separate transform units for different block sizes of video data. Many modern video codecs may use transformation algorithms based on discrete cosine transform (DCT) coding and motion compensation. Additionally, some video coding standards, such as the H.26x and MPEG formats, may use motion-compensated DCT hybrid coding, known as block motion compensation (BMC) or motion-compensated DCT (MC DCT). Furthermore, in some codecs, an RDO process may include a DCT that may be followed by entropy encoding. To save power during this RDO process, primary RDO core 804 and/or secondary RDO core 806 may each include a plurality of transform units that may be configured to transform video data in accordance with an RDO process of a video codec.

FIG. 8B shows an example view 810 of primary RDO core 804 and secondary RDO core 806. In this example, primary RDO core 804 may be configured to execute an RDO process by transforming video data (e.g., macroblocks, coding units, etc.) in accordance with an AVC/H.264 codec. Hence, primary RDO core 804 may include a plurality of transform units configured to transform blocks of video data having block sizes and/or dimensions that may be supported by and/or included in a specification of the AVC/H.264 codec. In this example, primary RDO core 804 may include transform unit 812 and transform unit 814 that may be configured to execute transformation operations for intra-frame data having dimensions of four pixels by four pixels and eight pixels by eight pixels, respectively. As also shown in FIG. 8B, primary RDO core 804 may also include transform unit 816 and transform unit 818 that may be configured to execute transformation operations for inter-frame data having dimensions of four pixels by four pixels and eight pixels by eight pixels, respectively.

Likewise, secondary RDO core 806 may be configured to execute an RDO process by transforming video data (e.g., macroblocks, coding units, etc.) in accordance with a VP9 codec. Hence, primary RDO core 804 may include a plurality of transform units configured to transform blocks of video data having block sizes and/or dimensions that may be supported by and/or included in a specification of the AVC/H.264 codec. In this example, secondary RDO core 806 may include transform unit 820 and transform unit 822 that may be configured to execute transformation operations for intra-frame data having dimensions of four pixels by four pixels and eight pixels by eight pixels, respectively. As also shown in FIG. 8B, primary RDO core 804 may also include transform unit 816 and transform unit 818 that may be configured to execute transformation operations for inter-frame data having dimensions of four pixels by four pixels and eight pixels by eight pixels, respectively.

Unlike primary RDO core 804, secondary RDO core 806 may include transform unit 828 and transform unit 830 that may be configured to execute transformation operations for intra-frame data having dimensions of sixteen pixels by sixteen pixels and thirty-two pixels by thirty-two pixels, respectively. As also shown in FIG. 8B, secondary RDO core 806 may also include transform unit 832 and transform unit 834 that may be configured to execute transformation operations for inter-frame data having dimensions of sixteen pixels by sixteen pixels and thirty-two pixels by thirty-two pixels, respectively.

It may be noted that, although primary RDO core 804 and secondary RDO core 806 both may support similar types of blocks (e.g., intra-frame data and/or intra-frame data) and/or block sizes, the transform operations supported by each codec may differ. Hence, as an illustration, even though transform unit 812 included in primary RDO core 804 and transform unit 820 included in secondary RDO core 806 may both be configured to transform intra-frame video data having a block size of four pixels by four pixels, transform unit 812 and transform unit 820 may support and/or execute different transform operations to transform video data.

FIG. 8C is a flow diagram of an example method 840 for allocating shared resources in multi-tenant environments. The steps shown in FIG. 8C may be performed by any suitable computer-executable code and/or computing system, including system 800 in FIG. 8A and/or variations or combinations of one or more of the same. In one example, each of the steps shown in FIG. 8C may represent an algorithm whose structure includes and/or is represented by multiple sub-steps, examples of which will be provided in greater detail below.

As illustrated in FIG. 8A, at step 842, one or more of the systems described herein may receive, by an input packet processing module in a video encoding hardware pipeline, an input packet for video encoding. For example, input packet processing module 802 may receive an input packet for video encoding (e.g., by one or more of primary RDO core 804 and/or secondary RDO core 806).

At step 844, one or more of the systems described herein may receive a control signal from a CGC, the control signal including a primary signal or a secondary signal. For example, as shown in FIG. 8A, primary RDO core 804 may receive a control signal from CGC 808(a) or secondary RDO core 806 may receive a CGC from 808(b).

At step 846, one or more of the systems described herein may, when the control signal includes the primary signal, activate a primary RDO core within the video encoding pipeline that, when activated, adjusts a bit rate of an encoding, in accordance with a primary video codec, of the input packet. For example, primary RDO core 804 may activate upon receiving the control signal that includes the primary signal.

At step 848, one or more of the systems described herein may, when the control signal includes the primary signal, deactivate a secondary RDO core within the video encoding pipeline that, when activated, adjusts a bit rate of an encoding, in accordance with a secondary video codec, of the input packet. For example, secondary RDO core 806 may deactivate upon receiving the control signal that includes the primary signal.

At step 850, one or more of the systems described herein may, when the control signal includes the secondary signal, deactivate the primary RDO core and activate the secondary RDO core. For example, primary RDO core 804 may activate and secondary RDO core 806 may deactivate.

As discussed throughout the instant disclosure, the disclosed systems and methods may provide one or more advantages over traditional options for RDO, and especially within hardware-implemented video encoding pipelines. As described above, since conventional micro-architectures of RDO hardware used by some video codecs (e.g., AVC/H.264 and VP9) may be similar, traditional or conventional designs may share same hardware resources between two codecs such as a transform engine, quantization resources, inverse transform resources, interim buffers, etc.

However traditional implementations generally have design overhead that may have drawbacks, particularly when only one video codec is active. This overhead may save design area (e.g., silicon and/or packaging area), but may cause unnecessary power waste. The systems and methods disclosed herein may be deployed in data center applications where silicon area may not be a primary concern. Hence, the present systems and methods may trade off design and/or silicon area for power savings by separating hardware resources used for each video codec. As disclosed herein, the primary RDO core, configured to execute RDO operations for a primary video codec (e.g., AVC/H.264), and the secondary RDO core, configured to execute RDO operations for a secondary video codec (e.g., VP9), may each have independent hardware processing resources, but may share input packet processing resources. To further conserve power resources, each RDO core may include separate transform units as disclosed herein.

### EXAMPLE EMBODIMENTS

Example 22: A system comprising (1) an input packet processing module in a video encoding hardware pipeline that receives an input packet for video encoding, (2) a clock gating circuit that generates a control signal comprising a primary signal or a secondary signal, (3) a primary rate-distortion optimization (RDO) core within the video encoding hardware pipeline that, (a) when the control signal comprises the primary signal, adjusts a bit rate of an encoding, in accordance with a primary video codec, of the input packet, and (b) when the control signal comprises the secondary signal, is inactive within the video encoding hardware pipeline, and (4) a secondary RDO core within the video encoding hardware pipeline that, (a) when the control signal comprises the primary signal, is inactive within the video encoding hardware pipeline, and (b) when the control signal comprises the secondary signal, adjusts a bit rate of an encoding, in accordance with a secondary video codec, of the input packet.

Example 23: The system of example 22, wherein the primary RDO core comprises a primary plurality of transform units and the secondary RDO core comprises a secondary plurality of transform units.

Example 24: The system of example 23, wherein the primary plurality of transform units and the secondary plurality of transform units each comprise (1) a transform unit configured to transform intra-frame video data having a block size of four pixels by four pixels, (2) a transform unit configured to transform intra-frame video data having a block size of eight pixels by eight pixels, (3) a transform unit configured to transform inter-frame video data having a block size of four pixels by four pixels, and (4) a transform unit configured to transform inter-frame video data having a block size of eight pixels by eight pixels.

Example 25: The system of example 24, wherein the secondary plurality of transform units further comprise (1) a transform unit configured to transform intra-frame video data having a block size of sixteen pixels by sixteen pixels, (2) a transform unit configured to transform intra-frame video data having a block size of thirty two pixels by thirty two pixels, (3) a transform unit configured to transform inter-frame video data having a block size of sixteen pixels by sixteen pixels, and (4) a transform unit configured to transform inter-frame video data having a block size of thirty two pixels by thirty two pixels.

Example 26: The system of any of examples 22-25, wherein the primary video codec comprises an Advanced Video Coding (AVC/H.264) video codec.

Example 27: The system of any of claims 22-26, wherein the secondary video codec comprises a VP9 video codec.

Example 28: A method comprising (1) receiving, by an input packet processing module in a video encoding hardware pipeline, an input packet for video encoding, and (2) receiving, from a clock gating circuit (CGC), a control signal comprising a primary signal or a secondary signal, (3) when the control signal comprises the primary signal, (a) activating a primary rate-distortion optimization (RDO) core within the video encoding hardware pipeline that, when activated, adjusts a bit rate of an encoding, in accordance with a primary video codec, of the input packet, and (b) deactivating a secondary RDO core within the video encoding hardware pipeline that, when activated, adjusts a bit rate of an encoding, in accordance with a secondary video codec, of the input packet, and (4) when the control signal comprises the secondary signal, deactivating the primary RDO core and activating the secondary RDO core.

### Globally Distributed Data Warehouse Architecture

Very large distributed data warehouses may face numerous scaling challenges across dimensions of cost, usability, and/or performance. These scaling challenges may become harder in proportion to the number of physical scaling boundaries crossed by the data warehouse (e.g., inter-server, inter-rack, inter-data-center, inter-region, inter-continent, etc.). As the amount of data stored, and the computation needed to query such data, exceeds the limits of the boundary, additional steps must be taken to retain usability of the data warehouse, minimize cost, and maximize performance.

The systems described herein may create a single system image for a data warehouse (DW) across all the data centers (DC)s associated with the DW regardless of the physical region in which each DC is located. The term “data warehouse” may generally refer to any collection of data centers that store related data (e.g., data belonging to an organization). The term “data center” may refer to any physical location (e.g., a room, building, or complex of buildings) that stores multiple connected servers. In some embodiments, global metadata may span all regions and be available in any DC. In some examples, queries may be submitted at any location and the systems described herein may handle implementation, including location of execution (e.g., in which DC to execute the query), which copies of data to use, location of any intermediate output, and/or location(s) of results data.

In one embodiment, all persistent data may exist in at least a predetermined number of locations, such as at least three locations. In some embodiments, each location may be able to read the local copy without reference to any other location. In some examples, all copies may be active participants in queries, not just passive safety copies. By having all copies participate actively, data replication may become an operational advantage rather than an overhead cost.

In some embodiments, highly contended data segments may be replicated further (e.g., beyond a baseline of three copies) to gain increased compute scalability. In these embodiments, more valuable data may thus naturally be protected to a higher degree. Likewise, temporary or low-value data may be stored at a lower replication level (e.g., fewer than three copies), implicitly reducing the compute availability and data replication protection all as a consequence of a storage-level attribute (e.g., an attribute that flags the value of the data).

In one embodiment, a new single-image DW may use an exclusive structured query language (SQL) compute engine for all queries. For example, the DW may exclusively use Presto. In some examples, changes to support the DW may only be made to the exclusive SQL compute engine architecture, reducing the resources (e.g., in terms of technology, developer hours, admin hours, etc.) required to make changes. In some embodiments, other compute engines (e.g., Spark) and/or raw storage users may be supported natively and/or via a compatibility layer.

The architecture described above is predicated upon two main principles, data locality and push down processing, which will be discussed in greater detail below.

### Data Topology

In some embodiments, the systems described herein may include a query optimizer and/or resource planner that is designed and/or configured with an awareness of compute and/or input/output operations per second (IOPs) utilization in all candidate regions for required data partitions, bandwidth domains, latency domains, and/or network utilization.

In some embodiments, granularity of data locality may be per-partition and/or per-sub-partition, giving maximum flexibility for spreading highly utilized data segments. Data may be striped on a block or extent level, ensuring that the access heat-map is spread evenly across all member racks. In some examples, any single table may exist in its entirety at nominally three (or more) locations. In one embodiment, locality domains may be defined as follows, listed in order of increasing latency and decreasing bandwidth: (i) in-rack, (ii) in-pod (e.g., cross-rack) and/or in-DC (e.g., cross-pod), (iii) in-region, and/or (iv) out-region. Various different localities may have different constraints and/or benefits. For example, the in-rack locality domain may have no network uplink overhead due to connections being port-to-port only, while the in-region domain may be subject to inter-DC bandwidth constraints and/or latency differences, and/or the out-region domain may be subject to backbone constraints.

When data is arranged in locality domains, it may become possible to decompose a query plan into constituent fragments and to map those fragments over the locality domains via push down processing, as will be described in greater detail below. In some embodiments, the degree to which the systems described herein pursue locality (e.g., DC-level locality vs rack-level locality) may be determined empirically by analyzing data access patterns. In one embodiment, the systems described herein may be designed to be configurable to pursue different levels of locality.

In some embodiments, the systems described herein may schedule compute as close as physically possible to storage. In one embodiment, if the systems described herein pursue rack-level locality, 50% of any given rack may be used for storage and the remainder for compute. In some examples, rack composition may vary across differing execution functions. For example, data analysis may show that it is more efficient for some racks to have 100% compute content. In this example, the systems described herein may configure some racks to have 100% compute content.

### Software Architecture

In some embodiments, the systems described herein may be designed to scale globally by combining data locality, utilizing push down processing, and providing implicit data replication. In some examples, this may ensure that compute scales with data and/or that network ceases to be a hard dependency on DW scaling.

In one embodiment, the systems described herein may perform execution of an SQL query by decomposing the query into an execution plan (also known as a or query plan) which is then processed as a tree of execution units with dependencies between them. For example, a two table join may be joined by scanning the small table, building a hash table of the keys, and probing that hash table during the scan of the large table. If a third table were joined this would be represented as another table scan operation on the new table and an additional hash join to the output from the previous table join. The general goal of an execution plan is to filter early and to reduce, through joins and filtering, decreasing sized intermediate result sets as the tree converges back to the root node (which represents the whole query).

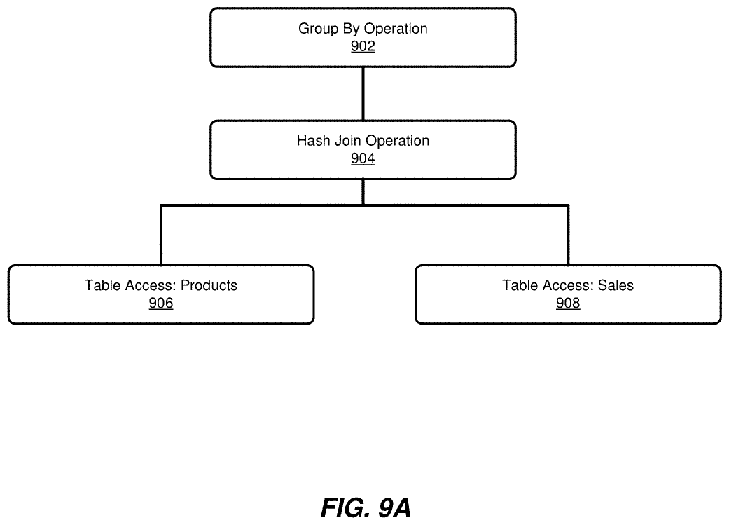

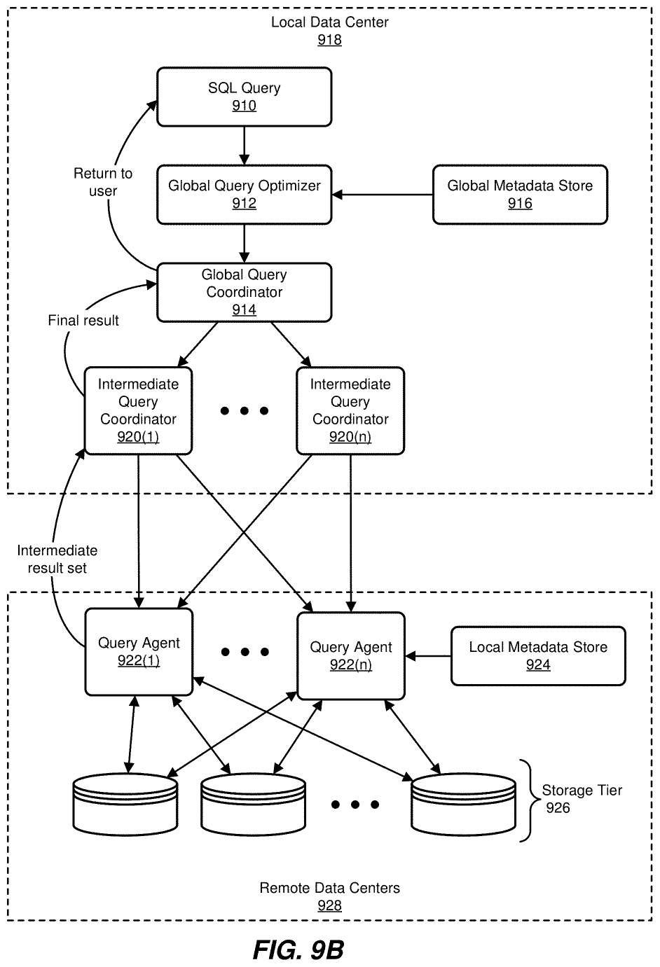

For example, as illustrated in FIG. 9A, the systems described herein may perform two table accesses, a table access: products 906 and a table access: sales 908. The systems described herein may perform a hash join operation 904 on the results of the two table accesses and may then perform a group by operation 902 on the joined data before presenting the results of the query to a user.

In some examples, the tree hierarchy may be decomposed into independent functions that match the physical layout of the data across regions. For example, as illustrated in FIG. 9B, a local data center 918 (e.g., local to the user making the query) may receive a SQL query 910 from a user. A global query optimizer 912 may retrieve information from a global metadata store 916 about the location (e.g., which DC stores each portion of the data) of the data requested by SQL query 910 and/or the size of the requested data. In some embodiments, global query optimizer 912 may send this information to a global query coordinator 914 that breaks the query up into fragments correlated to different regions and/or DCs and sends the fragments of the query to a set of intermediate query coordinators 920(1) through 920(n).

In some embodiments, intermediate query coordinators 920(1) through 920(n) may push down the query plan fragments and/or Bloom filters to a set of query agents 922(1) through 922(n) located in various remote data centers 928. In one embodiment, any or each of query agents 922(1) through 922(n) may query a local metadata store 924 for more specific location information (e.g., rack, server, partition, etc.). In some examples, query agents 922(1) through 922(n) may retrieve the relevant data from servers in storage tier 926 and may send intermediate results set back up to intermediate query coordinators 920(1) through 920(n). In one embodiment, intermediate query coordinators 920(1) through 920(n) may combine this data (e.g., via joins) and send a final result to global query coordinator 914, which may return the result to the user.

In some embodiments, the systems described herein may have advantages over methods where data and compute are 100% homogenized across a single DC, which may rely heavily on network resource and/or may not be able to scale outside a region (or even outside a DC). In some examples, the systems described herein may function efficiently because the volume of data passed back up the tree (from bottom to top) reduces dramatically in a sufficiently large number of cases (queries). In other examples, results data may be written to an output table in its own right to maintain efficiency, and such queries may be scheduled so that partition-wise output tables reside in the same DC as the input tables.

In some embodiments, the systems described herein may include a global metadata store. In some examples, a global metadata store may exist as a locality-aware service across all members of a region. In one example, a global query optimizer may only need high-level location information to determine where to send fragments of query plan, while DC-local details of specific storage nodes may be retained close to actual data and queried by the local fragment of the query plan. In some embodiments, the global metadata store may contain location, size, and/or optimizer statistics for every data object at extent level.

In one embodiment, a global query optimizer may use global metadata and/or distance metrics to calculate access cost for queries. In some examples, the global query optimizer may use resource management to manage the location(s) for execution in terms of compute availability, highest degree of local data availability, and/or network bandwidth. Additionally or alternatively, the global query optimizer may push a query execution plan to a global query coordinator in the DC that stores the greatest proportion of required data for a given query. In some examples, the global query coordinate may push fragments of a query plan to selected DCs and/or assemble a final result set.

In some embodiments, the systems described herein may include a materialized view-backed extract, transform, load (ETL) alternative. In some examples, a materialized view-backed ETL alternative may have efficiency advantages over a traditional ETL model.

In one embodiment, the systems described herein may include push down projections, predicates, and/or processing that send the compute components to the data. This configuration may minimize cross-domain input/output, minimize cross-domain inter-process communication, push down Bloom filters (e.g., to offload join processing), and/or push down SQL functions (e.g., for parallel processing at source).

In some embodiments, the systems described herein may incorporate fault tolerance and/or checkpointing. In some examples, increased scale may imply a higher failure rate and checkpoints may be used to allow recovery from partial failure. In some examples, the systems described herein may be configured to support large clusters. For example, the systems described herein may support clusters of 10,000 to 100,000 nodes.

In one embodiment, the systems described herein may incorporate storage hotspot monitoring and/or online and/or atomic relocation/rebalancing of partition data files without interrupting processing. Additionally or alternatively, the systems described herein may incorporate join monitoring to optimize physical location of tables that are frequently joined together and/or partition-wise locality of output tables to correspond with input tables.

### Hardware Architecture

In principle, the architecture of the systems described herein may not require any hardware changes (e.g., compared to existing hardware architecture at each location) other than deploying a standard rack configuration in the participating DCs. In some embodiments, there may be advantages in considering special treatment in the write path for each DC to provide additional fault tolerance during remote write operations, such as providing a temporary local write to an additional storage rack until the data is committed in the remote locations. In order to provide for the case where the remote location could be offline for long periods, as soon as the copy is in more than one location it, the systems described herein may age the copy out of the remote write cache and/or re-replicate the copy by an anti-entropy process at a later stage.

In some embodiments, any such staging location may be under comparatively high IOPs load and may therefore benefit from flash storage. In one embodiment, this flash storage may also be used for storage of temporary files (which may be excluded from any remote replication consideration).

### EXAMPLE EMBODIMENTS

Example 28: A system comprising (1) a plurality of data centers that each include plurality of servers that store data for an organization, (2) a global metadata store that stores location information for the data for the organization that is stored in the plurality of servers in the plurality of data centers, and (3) a global query engine that, based on the location information for the data stored in the global metadata store, directs a plurality of local query agents that are each hosted within a data center within the plurality of data centers to retrieve a portion of the data from the plurality of servers in the plurality of data centers.

Example 29: The system of example 28 may further include a plurality of intermediate query coordinators that receive instructions from the global query engine, send instructions to the plurality of local query agents, receive data from the plurality of local query agents and send data to the global query engine.

Example 30: The system of examples 28 and 29, where the global query engine includes (1) a global query optimizer that retrieves metadata from the global metadata store and sends a query execution plan to a global query coordinator and (2) the global query coordinator that (a) receives the query execution plan from the global query optimizer, (b) sends portions of the query execution plan to the plurality of local query agents, (c) receives results data from the plurality of local query agents, and (d) assembles the results data.

### Mass and Volume Efficient Integration of Inter-Satellite Link Terminals to a Satellite Bus

Aspects of the present disclosure are generally directed to a satellite (e.g., a communication satellite) including at least one communication terminal, such as an inter-satellite link (ISL) terminal configured to communicate with one or more other satellites. In some examples, a communication terminal may allow communication with a ground station. An example communication terminal may include one or more steerable and/or aperture elements and/or one or more electronic elements, which may include remotely located electronic elements.

As will be explained in greater detail below, embodiments of the present disclosure include a communication terminal (such as an ISL terminal) having an electronic chassis and one or more steerable elements that may also function as a satellite bus structural element. The structural chassis may protect the ISL terminal (e.g., from sun exposure or mechanical disturbance with solar array drives) and may provide an optimal mass/volume integration into the satellite. Features from any of the embodiments described herein may be used in combination with one another in accordance with the general principles described herein.

In some examples discussed herein, an ISL may be discussed as a representative example. However, examples referring to an ISL are not intended to be limited thereto and examples may also include any other form of communication terminal, such as a communication terminal configured to communicate with a ground station. Examples may include spacecraft generally, such as satellites.

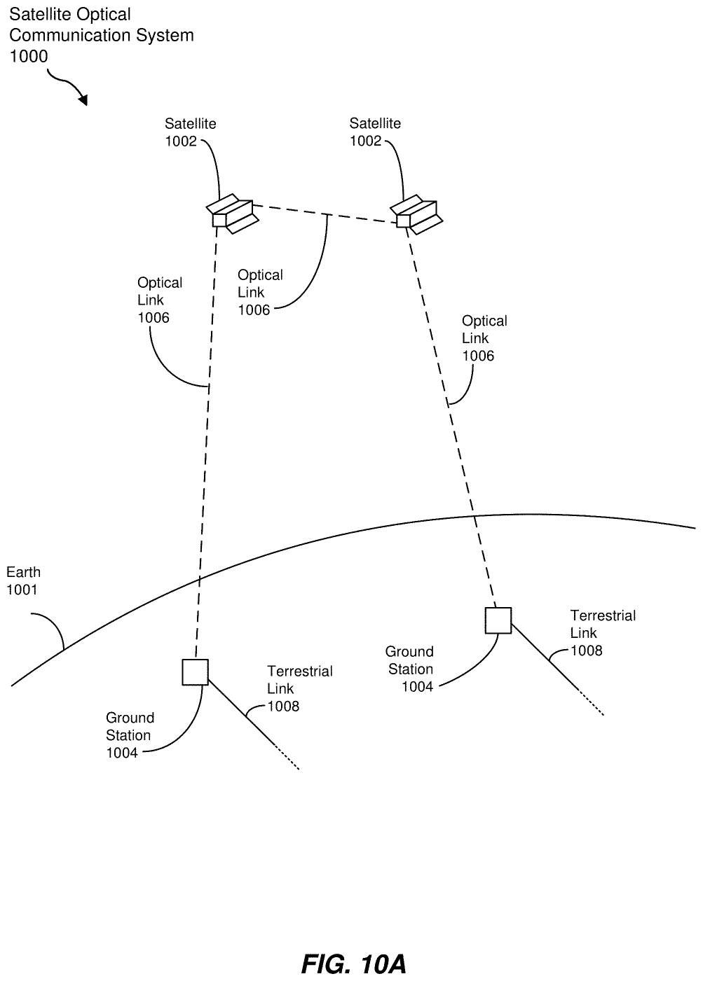

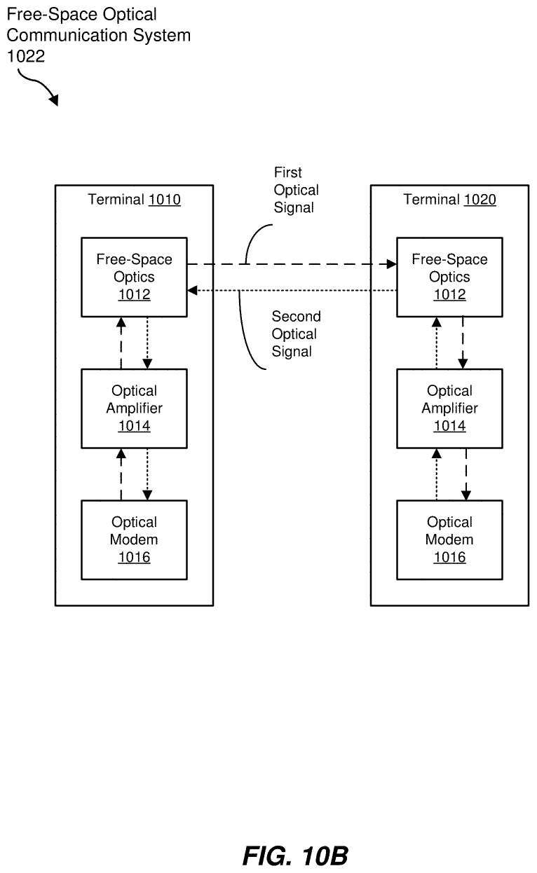

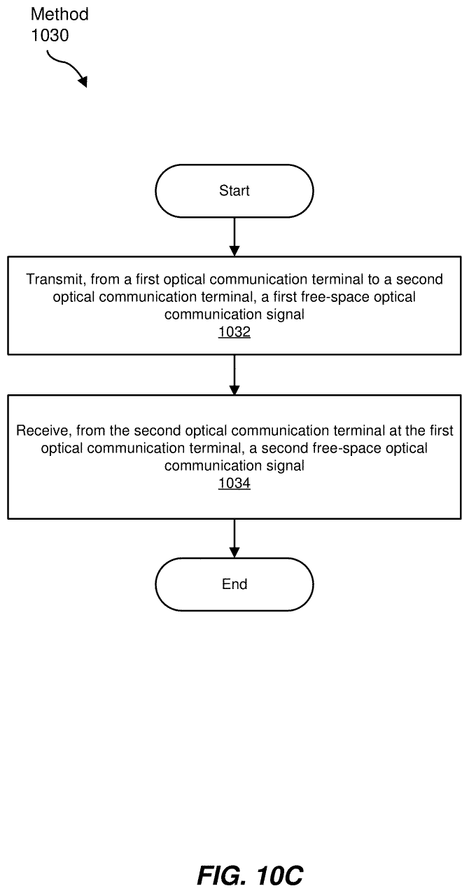

FIG. 10A is a schematic representation of an exemplary satellite optical communication system 1000 in which FSO communication terminals, such as ISL terminals, and associated methods may be employed. In satellite optical communication system 1000, one or more satellites 1002 (e.g., low Earth orbit (LEO) communication satellites that may be configured as a communication constellation) may facilitate communication between two or more ground stations 1004 (e.g., ground stations that are geographically separated on Earth 1001 to an extent that direct communication therebetween is not readily achievable) using optical links 1006. The satellites may each include an ISL terminal, for example, to communicate with each other and/or other satellites. In some examples, each ground station 1004 may be coupled to other communication devices via terrestrial links 1008 (e.g., wired communication links, wireless communication links, and the like), thus serving as a portion of a larger communication network. In some embodiments, each optical link 1006 may operate as a unidirectional or bidirectional communication link.

The satellites 1002 may have a general configuration based on a satellite bus and may include one or more communication terminals such as an ISL. In some examples, one or more components of the ISL may also provide structural support (or other function) related to a different subsystem of the satellite bus. In some examples, components of a different subsystem of the satellite bus may provide a housing or other component of the ISL.

In satellite optical communication system 1000, each optical link 1006 between the satellite 1002 and a ground station 1004 may be formed using suitable communication protocols. Optical communication between the satellites may use respective ISL terminals, and may include a free-space optical link. An ISL terminal may be configured as described herein.

While FIG. 10A represents one particular example of an FSO communication system, other satellite configurations may also benefit from application of the various principles described herein.

FIG. 10B is a block diagram of an exemplary FSO (free-space optical) communication system 1022. As depicted in FIG. 10B, FSO communication system 1022 may include a first terminal 1010 and a second terminal 1020 between which a first optical signal of a particular wavelength may be transmitted from terminal 1010 to second terminal 1020. Also, a second optical signal may be transmitted from second terminal 1020 to first terminal 1010, thus forming a bidirectional communication link between terminals 1010 and 1020. Further, as depicted in FIG. 10B, each terminal 1010 and 1020 may include free-space optics 1012, an optical amplifier 1014, and an optical modulator-demodulator (modem) 1016. Terminals 1010 and 1020 may each include other components or elements, but such components are not specifically discussed herein to facilitate and focus the following discussion.

In some examples, free-space optics 1012 may include one or more lenses, mirrors, actuators, and/or other optical, electrical, or mechanical components. In first terminal 1010, free-space optics 1012 may receive an optical signal from optical amplifier 1014 and transmit that optical signal (e.g., an optical signal having a particular wavelength) in free space (e.g., to second terminal 1020). Further, free-space optics 1012 of first terminal 1010 may receive a second optical signal from second terminal 1020 and direct that signal to optical amplifier 1014.

An FSO communication terminal as discussed above in relation to FIG. 10B may be used in an example communication terminal such as an ISL. A satellite according to examples of the present invention may include one or more FSO communication terminals. Optical communication, such as FSO communication, between the satellites may use a respective ISL terminal within the satellite. The ISL terminal may be configured as described herein.

FIG. 10C is a flow diagram of an exemplary method 1030 of providing FSO communication, which may be between satellites or, in some examples, between a satellite and a ground station or other spacecraft. In the method 1030, at step 1032, a first free-space optical communication signal (e.g., a first optical signal) may be transmitted from a first optical communication terminal (such as a satellite ISL) to a second optical communication terminal (such as a second satellite ISL or a ground station). At step 1034, a second free-space optical communication signal (e.g., second optical signal) may be received at the first optical communication terminal from the second optical communication terminal. In some embodiments, the transmitted and/or received wavelengths may be infra-red (IR) wavelengths, such as near-IR wavelengths. Method 1030 may be performed by an FSO communication system such as described herein.

Inter-satellite link (ISL) terminals have packaging and integration aspects when integrated into a satellite bus. Their most effective positions within the satellite and their need for unobstructed field of regard relative to the other satellites in the constellation often creates a trade-off between the ISL and other satellite elements (such as the ground facing antennas, the radiators, the solar panels, or structural members).

Placing the ISL terminals on the earth facing deck can be ideal for unobstructed field of regard, but reduces the available area for ground facing antennas, and subjects them to Earth's albedo (which can have challenging thermal and glint implications).

Placing the ISL terminals on the uppermost deck can be ideal for unobstructed field of regard, but reduces the available area for radiator surfaces, and subjects the ISL terminals to a challenging thermal environment in terms of facing deep space with periodic sun exposure (and may also have challenging glint implications). This location may also move the ISL terminals closer to sources of mechanical disturbance such as solar array drives.

Placing the ISL terminals toward the center of the satellite avoids the problem of taking away valuable earth facing area, solar facing area, or radiator area, and may create a more benign thermal and glint environment for the ISL terminals, but it creates additional challenges for a large unobstructed field of regard. Using perimeter walls or panels as structural elements may require extremely large apertures for the ISLs to look through, and is not as mass efficient as using other simpler structures, such as beams. Structural beams may be located so as to avoid at least partial blocking the field of regard of the ISL terminals, and the ISL may in some examples be located within a central portion of the satellite. The location of structural elements may also modify the satellite's mass moment of inertia. It may be advantageous to use ISL components as structural elements to avoid adding mass, and these components may be located out of the field of regard of the ISL.

For a non-movable sensor or antenna, the field of regard may be effectively the same as the field of view. However, for a moveable sensor, the field of regard may be appreciably larger than the field of view. For example, the orientation of the sensor may be adjusted allowing a field of regard that may be greater than the field of view for a fixed orientation.

In this context, a satellite bus may refer to a general configuration of the various satellite components and subsystems. For example, an example satellite bus may include the configuration of one or more communication terminals (such as an ISL), propulsion and attitude control units, navigation control, thermal control, attitude control, structural element, command and data handling systems, and electrical power handling systems (e.g., solar cells, batteries, power controllers, regulators, and the like). A satellite constellation may include a plurality of satellites designed based on a similar satellite bus. The satellite bus may be modified to provide specific design requirements.

ISL terminals may comprise one or more steerable/aperture elements and one or more remotely located electronics elements. The mass to volume integration ratio of an ISL terminal and a satellite bus may be improved by one or more of several approaches, as described in more detail below.

In some examples, a satellite may include at least one communication terminal (e.g., an ISL terminal), and may include dual-purposed chassis components. The mass to volume ratio of the satellite may be optimized, or at least appreciably improved, by the chassis configuration. In some examples, the chassis may provide mechanical support (e.g., internal printed circuit board (PCB) mounts, external steerable elements) and operational functionalities for the satellite, such as for electronic components. In some examples, the ISL chassis configuration may be configured to not appreciably impede the function of satellite components, for example, by not obstructing components such as antennas or sensors. In some examples, the ISL terminal may include one or more steerable elements (e.g., an antenna) which may be integrated as part of the satellite chassis.

In some examples, an electronics chassis (such as an ISL chassis), or one or more components of the ISL, may be further configured for use as a satellite bus structural element.

In some examples, portions of the satellite that include structures such as beams, panels, cylinders, and/or other components (e.g., to connect two elements or decks of the satellite together) may be configured to further act as a housing for the ISL electronics.

In some examples, one or more steerable elements and/or the housing of the ISL terminal antenna and/or aperture may be further configured as a satellite bus structural element. In some examples, portions of the satellite including structures such as beams, trusses, panels, cylinders, electrical components, and/or other components (e.g., to connect two elements or decks of the satellite together) may be configured to act as a protective or functional housing for a steerable antenna and/or aperture, or for one or more other ISL components.

In some examples, mass (e.g., components) that may be used to house the ISL terminal may be further configured to provide one or more structural element of the satellite itself, such as a support structure for one or more satellite components, such as different satellite bus subsystems. For example, a structural component of the satellite may include at least a portion of the ISL housing or other ISL component. Mass that would be required to house ISL components may be dual-purposed to provide a structural element of the satellite itself. Structural volume that would otherwise be unavailable for active/functional components may be dual purposed to allow ISL inclusion. The optimal placement and wide field of regard that may be used by intersatellite links to communicate with the rest of the constellation may be made more achievable by incorporating the potential obstructions into the design of the ISL.

In some examples, structural volume that would otherwise be unavailable for active or otherwise functional components may be configured (e.g., dual purposed) to enable an ISL terminal to be included within the satellite, in some cases, while adding little or no additional mass.

In some examples, a satellite bus component may include a beam, truss, panel (e.g., an exterior panel, support panel for a solar cell, or other panel), other structural component, conduit, electrical conductor (e.g., wire, transmission line, plate, ground plane), radiation shielding component, insulating panel, thermal or electrical conductor, battery, charge storage device, regulator, circuit board assembly, vibrational isolation assembly, or other satellite component. A satellite bus component may also function as at least a portion of a housing or component of a communication terminal such as an ISL. In some examples, a component of a communication terminal such as an ISL may additionally function as a satellite bus component such as discussed herein.

In some examples, the optimal placement and wide field of regard used by an inter-satellite link (e.g., to communicate with one or more other satellites, e.g., other satellites of the constellation) may be facilitated by including the potential obstructions within the configuration of the ISL, for example, by moving potential obstructions out of the field of regard.

In some examples, a method of fabricating a satellite includes fabricating a communication terminal (e.g., an ISL) including a terminal component, and fabricating the satellite using the terminal structural component as a satellite structural component. Example terminal components include component mounts for the communication terminal (including electrical and/or optical component mounts), antenna components, aperture components, housing components, heatsinks (e.g., laser heatsinks), electrical and/or thermal shielding components, mirrors, vibration isolators, other optical components, beam steering components, and the like.

In some examples, a satellite may include at least one communication terminal (e.g., an ISL terminal); and at least one satellite structural component that also forms part of a terminal component. A terminal component may include a housing, component mount, aperture component, or antenna component for the communication terminal. Examples also include analogous improved configurations of spacecraft other than satellites, for example, in which an inter-spacecraft terminal (analogous to an ISL) may share components with other spacecraft subsystems and/or structural elements in a manner similar to examples described herein. Examples also include satellites configured to communicate with a ground station.

In some examples, a satellite may include at least one communication terminal (e.g., an ISL terminal) and at least one satellite structural component that also forms part of a housing for the communication terminal. The at least one structural component of the satellite may be configured to provide the housing for the communication terminal within the satellite.

In some examples, a satellite may include at least one communication terminal (e.g., an ISL terminal); and at least one terminal component that also acts as a structural element for the satellite. The at least one terminal component may include a circuit board, antenna component (e.g., a radiative element, feedline, backplane, or other antenna component), component mount, aperture component, housing, or other ISL component. The at least one terminal component may provide an additional function for the satellite bus configuration, for example, by being part of the satellite bus. For example, the terminal component may also be a component of a different subsystem of the satellite bus.

In some examples, a communication satellite may include at least one communication terminal, such as an inter-satellite link (ISL) terminal configured to communicate with one or more other satellites. An example ISL terminal (sometimes referred to as an ISL for conciseness) may include one or more steerable elements and/or aperture elements. In some examples, these elements may also function as a satellite structural element, such as a chassis component. The chassis configuration may protect the ISL terminal and may provide an optimal mass/volume integration for the satellite. In some examples, an ISL component may also function as a satellite structural component. In some examples, a satellite structural component (such as a beam, panel, cylinder, and/or other component) may also function as part of an ISL housing or as a communication terminal component such as an aperture or antenna component. In some examples, an aperture may include one or more aperture components defining an opening therein (which may also be referred to as an aperture), such as a ring, beam, or other aperture component.

### EXAMPLE EMBODIMENTS

Example 31: A communication satellite including a communication terminal including at least one communication terminal component, wherein the at least one communication terminal component is also a satellite structural component.

Example 32: The communication satellite of example 31, where the satellite structural component is a satellite chassis component.

### Overcome Retention Limit for Memory-Based Distributed Database Systems

In some cases, memory-based distributed database systems may be used to diagnose online issues, report event trends, and/or monitor services' health. In some configurations, each table in a database system may be associated with a retention configuration that sets how long the data will be stored before being pruned (e.g., deleted from the table). In some cases, out-of-retention data that is pruned from a table may be stored elsewhere in order to be available for queries that cover the span of time relevant to the data. Storing larger amounts of data and/or storing data for longer periods of time may lead to a variety of scaling challenges in terms of logistics, power limits, network bandwidth limits, maintenance limits, and/or cost.

The systems described herein may address these scaling issues by offloading out-of-retention data into a warehouse. The term “warehouse,” as used herein, generally refers to any physical location or combination of physical locations (e.g., multiple data centers in different regions) that houses physical data storage media. In some examples, more recent data may be used (e.g., queried, retrieved, etc.) more frequently than out-of-retention data. Because data stored in warehouses may be physically stored on disk drives rather than solid state memory, it may be more cost-efficient to store out-of-retention data that is seldom used on the cheaper but slower hardware while continuing to store frequently accessed data on more expensive but faster hardware.

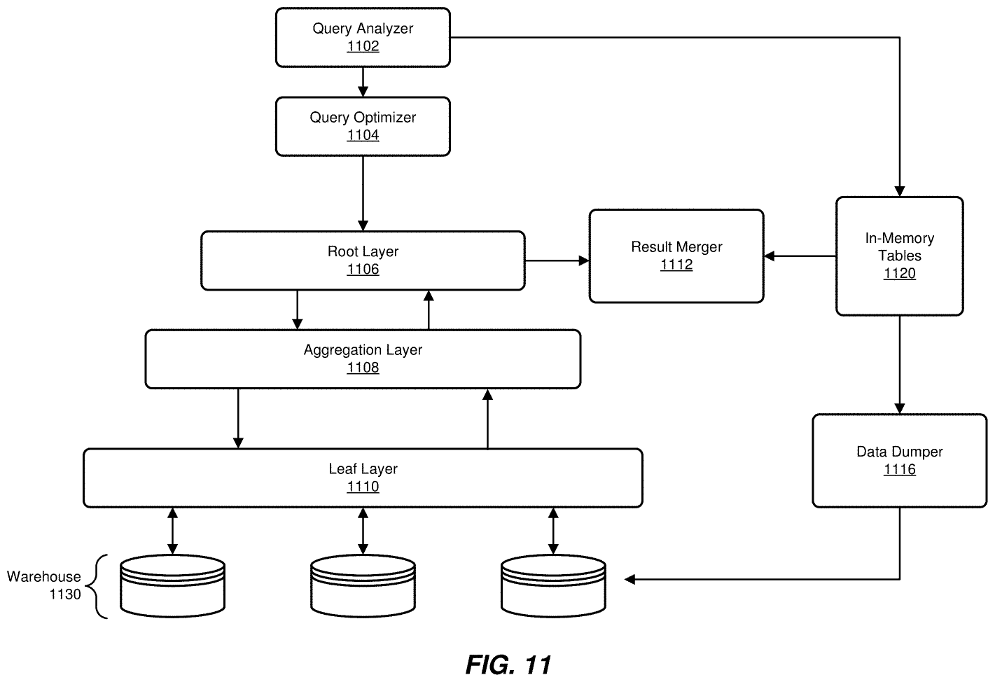

In order to efficiently query data stored in this way, the systems described herein may structure queries and/or returned results in a way that is tailored to this data storage configuration. For example, as illustrated in FIG. 11, the systems described herein may include a query analyzer 1102 that receives queries and breaks the queries into two parts based on a data boundary. In one embodiment, query analyzer 1102 may set the data boundary to be the timestamp of the oldest data sample for an in-memory table. In this embodiment, one part of the query will be directed to data that is stored in in-memory tables 1120 and the other part of the query will be directed to out-of-retention data stored in warehouse 1130.

In one example, the systems described herein may receive the query Q, “SELECT a, b, c FROM foo WHERE time>=1 AND time<=11”. If the data boundary is at time 4, query analyzer 11002 may break the query into Q1, “SELECT a, b, c FROM foo WHERE time>=1 AND time<4” and Q2, “SELECT a, b, c FROM foo WHERE time>=4 AND time<=11”. In this example, Q1 may represent the query using warehouse data (e.g., from warehouse 1130) and Q2 may represent the query using data in the memory (e.g., from in-memory tables 1120). In this way, the systems described herein may use in-memory data to speed up the query as much as possible while offloading a portion of the query to warehouse 1130 if the query range is longer than the table retention configuration for in-memory tables 1120.

In some embodiments, after query analyzer 1102 breaks the query into two portions, a query optimizer 1104 may further translate the warehouse portion of the query to leverage the warehouse index. In one embodiment, the in-memory database system may use time for indexing and the time condition may always be included in a query, enabling query optimizer 1104 to translate the query to use “ds” and “ts” as partition columns representing a date and an hour. For example, if query optimizer 1104 receives the query, “SELECT a, b, c FROM foo WHERE time>=1 AND time<4”, query optimizer 1104 may translate that query into “SELECT a, b, c FROM foo WHERE time>=1 AND time<4 AND ds>=(convert timestamp 1 into date) AND ds<(convert timestamp 4 into date) AND ts>=(convert timestamp 1 into hour) AND ts<(convert timestamp 4 into hour)”. In some embodiments, for columns other than time, the systems described herein may provide an option in the frontend (e.g., via a user interface) to customize the partition columns. Formulating a query to include partition columns may decrease response time because the search is not scanning the entire range of data, but only the specific portion that is relevant.

In some embodiments, query optimizer 1104 may send the query portion directed to the warehouse data to a root layer 1106. In one embodiment, root layer 1106 may scan through the warehouse metadata for warehouse 1130 and generate a file descriptor for each portion of data. In some examples, the systems described herein may assign all file descriptors belonging to one query to available leaf nodes (e.g., worker nodes in a leaf layer 1110) based on current traffic, meaning that a busy server may receive less work than an idle server. The systems described herein may then distribute this assignment information into an aggregation layer 1108. Aggregation layer 1108 may be designed to distribute the assignments from root layer 1106 to nodes in leaf layer 1110 and/or aggregate multiple partial results from leaf layer 1110 into one aggregated result.

In some embodiments, leaf layer 1110 may be the layer loading the data from warehouse 1130 and applying operations (e.g., aggregating, filtering, etc.) to this data. In one embodiment, the systems described herein may include two layers of data operation in each leaf node within leaf layer 1110. In this embodiment, the first layer may directly access warehouse data files to retrieve uncompressed data and parse that data into multiple batches. In some embodiments, the first layer may support simple filtering, column projection, limited data operators, and/or limited user defined functions. In some embodiments, the second layer may take the output of the first layer and finalize the results. In one embodiment, to improve query speed, the systems described herein may push down filter operators, projection operators, limit operators, and/or other relevant operators into the first layer to trim data efficiently.

After the results from each aggregator in aggregation layer 1108 are returned, root layer 1106 may merge all partial results into one and present the merged result data to a result merger 1112. When query results from warehouse 1130 part in-memory tables 1120 are both returned, result merger 1112 may merge the two partial results into one and present that into the frontend (e.g., the user interface used to input the query).

Based on the type of data that the user requested, the systems described herein may apply different strategies for finalizing and/or merging the retrieved data. For example, if users request time series data, the systems described herein may finalize both partial results individually and merge the finalized partial results together. However, if users request the aggregated data across the data boundary, the systems described herein may request intermediated results for both queries and finalize results in result merger 1112.

In some embodiments, root layer 1106 may include a full result cache that is used to speed up repeated queries by using a key value store. The key is the query SQL, and its value is the query results. In some examples, if multiple requests for the same query are sent to the system simultaneously, the systems described herein may be able to recognize these queries and only allow the first one to proceed, blocking the other queries until the first query receives results and then reusing those results for the other queries. In this way, the systems described herein may avoid wasting computing resources to do the same operations (data loading, filtering, etc.) multiple times. Additionally or alternatively, if multiple requests for the same query are sent to the system sequentially, the systems described herein may be able to speed up the following query because the results are cached in the full result cache already.

In some embodiments, a data dumper 1116 may tail data from the data source (e.g., in-memory tables 1120) and write that into warehouse 1130 regularly. For example, data dumper 1116 may write data to warehouse 1130 in accordance with a data pruning schedule.

### EXAMPLE EMBODIMENTS

Example 33: A system comprising (1) a plurality of database tables that store in-memory data and are configured with a retention configuration that determines when out-of-retention data is deleted from the plurality of database tables; (2) a data warehouse that comprises a plurality of physical storage media and that is configured to store the out-of-retention data indefinitely; (3) a data dumper that copies the out-of-retention data from the plurality of database tables to the physical storage media in the data warehouse; and (4) a query engine that (a) receives a query for data that comprises both the in-memory data and the out-of-retention data; (b) splits the query into a first query portion relevant to the in-memory data stored in the database tables and a second query portion relevant to the out-of-retention data stored in the data warehouse; (c) queries the database tables with the first query portion; (d) queries the data warehouse with the second query portion; and (e) merges results of the first query portion and results of the second query portion into a finalized result for the query.

As detailed herein, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.”Finally, for ease of use, the terms “including” and “having” (and their derivatives), as used in the specification and claims, are interchangeable with and have the same meaning as the word “comprising.”

What is claimed is:

1. A method comprising at least one of:
a method for privacy-aware infrastructure comprising:
annotating stored data with a privacy policy such that each subset of the stored data is annotated with a subset of the privacy policy that applies to the subset of the stored data;
identifying a privacy layer that enforces the privacy policy on all application programming interfaces that interact with the stored data;
detecting that an application programming interface is interacting with a subset of the stored data;
enforcing, by the privacy layer, the subset of the privacy policy that applies to the subset of the stored data; and
propagating, by the application programming interface, a privacy context relevant to the subset of the privacy policy as part of interacting with the subset of the stored data;
a method for scaling images comprising:
identifying, for scaling an input image to an output image, output dimensions for the output image;
generating, based on the output dimensions, a coefficient table comprising a plurality of index tables including at least a first channel table and a second channel table;
determining, for each output pixel of the output image, the output pixel using the coefficient table and one or more input pixels; and
storing the determined output pixels as the output image;
a method for scalable motion search comprising:
partitioning a source block of pixels from a source frame into one or more source grids and a reference window of pixels from a reference frame into a plurality of reference grids, wherein each of the one or more source grids is associated with one or more of the plurality of reference grids; and
for each of the one or more source grids along a dimension:
retrieving, from a reference buffer, a first reference grid of the plurality of reference grids corresponding to a current dimension value for the source grid;
reading, from a local reference buffer, a second reference grid of the plurality of reference grids corresponding to a prior dimension value for the source grid;
performing an operation with the source grid, the first reference grid, and the second reference grid; and
replacing, in the local reference buffer, the first reference grid with the second reference grid; and
a method for hardware optimization comprising:
receiving, by an input packet processing module in a video encoding hardware pipeline, an input packet for video encoding;
receiving, from a clock gating circuit, a control signal comprising a primary signal or a secondary signal;
when the control signal comprises the primary signal:
activating a primary rate-distortion optimization core within the video encoding hardware pipeline that, when activated, adjusts a bit rate of an encoding, in accordance with a primary video codec, of the input packet; and
deactivating a secondary rate-distortion optimization core within the video encoding hardware pipeline that, when activated, adjusts a bit rate of an encoding, in accordance with a secondary video codec, of the input packet; and
when the control signal comprises the secondary signal, deactivating the primary rate-distortion optimization core and activating the secondary rate-distortion optimization core.

2. The computer-implemented method of claim 1, wherein annotating the stored data with the privacy policy comprises:
schematizing the stored data with a unified data taxonomy; and
associating each category of the unified data taxonomy with a relevant subset of the privacy policy.

3. The computer-implemented method of claim 1, further comprising:
identifying code that is not annotated with privacy context derived from the privacy policy; and
annotating the code with the privacy context.

4. The computer-implemented method of claim 1, wherein annotating the stored data with the privacy policy comprises integrating the stored data with an end-to-end data lineage graph.

5. The computer-implemented method of claim 4, wherein propagating, by the application programming interface, the privacy context comprises updating the end-to-end data lineage graph with information about the application programming interface interacting with the subset of the stored data.

6. A system comprising at least one of:
a system for data distribution comprising:
a plurality of data centers that each comprise plurality of servers that store data for an organization;
a global metadata store that stores location information for the data for the organization that is stored in the plurality of servers in the plurality of data centers; and
a global query engine that, based on the location information for the data stored in the global metadata store, directs a plurality of local query agents that are each hosted within a data center within the plurality of data centers to retrieve a portion of the data from the plurality of servers in the plurality of data centers;
a system for hardware optimization comprising:
an input packet processing module in a video encoding hardware pipeline that receives an input packet for video encoding;
a clock gating circuit that generates a control signal comprising a primary signal or a secondary signal;
a primary rate-distortion optimization core within the video encoding hardware pipeline that:
when the control signal comprises the primary signal, adjusts a bit rate of an encoding, in accordance with a primary video codec, of the input packet; and
when the control signal comprises the secondary signal, is inactive within the video encoding hardware pipeline; and
a secondary rate-distortion optimization core within the video encoding hardware pipeline that:
when the control signal comprises the primary signal, is inactive within the video encoding hardware pipeline; and
when the control signal comprises the secondary signal, adjusts a bit rate of an encoding, in accordance with a secondary video codec, of the input packet; and
a system for data distribution comprising:
a plurality of database tables that store in-memory data and are configured with a retention configuration that determines when out-of-retention data is deleted from the plurality of database tables;
a data warehouse that comprises a plurality of physical storage media and that is configured to store the out-of-retention data indefinitely;
a data dumper that copies the out-of-retention data from the plurality of database tables to the physical storage media in the data warehouse; and
a query engine that:
receives a query for data that comprises both the in-memory data and the out-of-retention data;
splits the query into a first query portion relevant to the in-memory data stored in the database tables and a second query portion relevant to the out-of-retention data stored in the data warehouse;
queries the database tables with the first query portion;
queries the data warehouse with the second query portion; and
merges results of the first query portion and results of the second query portion into a finalized result for the query.

7. A communication satellite including a communication terminal including at least one communication terminal component, wherein the at least one communication terminal component is also a satellite structural component.

8. The communication satellite of claim 7, wherein the satellite structural component is a satellite chassis component.
